(19) United States
(12) Patent Application Publication
(10) Pub. No.: US 2025/0061528 A1
(43) Pub. Date: Feb. 20, 2025

(54) AI-ENABLED VISUAL WORKFLOW AND MODEL FOR SUPPORTING INTERACTIONS ACROSS MULTIPLE LEARNING ENVIRONMENTS AND SYSTEMS

(71) Applicant: RedCritter Corp., Flower Mound, TX (US)

(72) Inventors: Robert M. Beaty, Flower Mound, TX (US); Randy M. Whelan, Coppell, TX (US); Erika D. Lambert, Flower Mound, TX (US); James L. Rockett, JR., Carrollton, TX (US)

(21) Appl. No.: 18/450,992

(22) Filed: Aug. 16, 2023

(51) Int. Cl. G06Q 50/20; G09B 7/077

(52) U.S. Cl. CPC G06Q 50/20; G09B 7/077

(57) ABSTRACT

An AI-enabled visual workflow and model is provided for supporting interactions across multiple learning environments and systems. An admin can access a visual workflow editor to create workflows using the visual flow-based model. These workflows can be stored as workflow templates consisting of textual representations of interconnected nodes and any inputs, parameters, and outputs for the nodes. When a workflow is assigned to a student, the corresponding workflow template can be converted into an object model that a workflow processor can execute to dynamically generate a user interface representing the workflow. Workflows can be configured to include metaverse nodes by which a metaverse can be launched to enable the students to play as part of completing the workflows. Achievement nodes in the workflows can be configured to cause the corresponding achievements to be made available as virtual achievements in the metaverse.

### CROSS-REFERENCE TO RELATED APPLICATIONS

N/A

### BACKGROUND

Schools and other educational/learning institutions struggle to maintain student engagement and promote successful learning outcomes. The pandemic has exacerbated such struggles. With the return of in-person education, schools and teachers are struggling with students' lack of motivation, behavior, socialization and focus.

### BRIEF SUMMARY

The present invention extends to an AI-enabled visual workflow and model for supporting interactions across multiple learning environments and systems. An admin can access a visual workflow editor to create workflows using the visual flow-based model. These workflows can be stored as workflow templates consisting of textual representations of interconnected nodes and any inputs, parameters, and outputs for the nodes. When a workflow is assigned to a student, the corresponding workflow template can be converted into an object model that a workflow processor can execute to dynamically generate a user interface representing the workflow. The object model can also subscribe to events to await input from the student or other user that is required to continue execution of the workflow. AI nodes can be defined within workflows to enable AI functionality to be provided to a student in a structured manner.

Workflows can be configured to include metaverse nodes by which a metaverse can be launched to enable the students to play as part of completing the workflows. The metaverse nodes can be used to define limits on how long the students will be allowed to play in the metaverse. Achievement nodes in the workflows can be configured to cause the corresponding achievements to be made available as virtual achievements in the metaverse. The virtual achievements can be spawned in the metaverse to allow the students to find them. When the students find virtual achievements, the corresponding achievements can be issued to the students outside the metaverse.

In some embodiments, the present invention may be implemented as a method for implementing workflows for supporting interactions across multiple learning environments and systems. A visual workflow editor may receive input that defines a plurality of nodes and interconnects the nodes to form a first workflow. The plurality of nodes may include a metaverse node. The first workflow may be started for a student. Upon reaching the metaverse node of the first workflow, a metaverse instance may be launched. One or more virtual achievements may be placed in the metaverse instance. The one or more virtual achievements may be defined in the first workflow.

In some embodiments, the plurality of nodes may include one or more achievement nodes that define the one or more virtual achievements.

In some embodiments, the one or more achievement nodes may define one or more achievements and may specify an option to cause the one or more achievements to be made available as the one or more virtual achievements in the metaverse instance.

In some embodiments, the metaverse node may identify a type of the metaverse instance.

In some embodiments, the metaverse node may specify an identifier of a world for the metaverse instance.

In some embodiments, the metaverse node may specify a play time. It may be determined that the play time has elapsed and the metaverse instance may be terminated.

In some embodiments, a first workflow template may be generated for the first workflow. The first workflow template may comprise a textual representation of each of the nodes including any inputs, parameters and outputs for the nodes. Starting the first workflow for the student may include converting the first workflow template into an object model for the first workflow and executing the object model for the first workflow in a workflow processor.

In some embodiments, at least one of the plurality of nodes may be configured to provide artificial intelligence (AI) functionality. A student interface that presents a user interface representing the first workflow to the student may interface with an AI application programming interface (API) to integrate the AI functionality into the user interface.

In some embodiments, launching the metaverse instance may include logging the student in to the metaverse instance.

In some embodiments, the one or more virtual achievements may be identified by querying a virtual achievement database using an identifier of the student.

In some embodiments, the one or more virtual achievements may be defined in the virtual achievement database in response to executing one or more corresponding achievement nodes in the first workflow.

In some embodiments, in response to the student discovering a first virtual achievement of the one or more virtual achievements in the metaverse instance, a first achievement corresponding to the first virtual achievement may be issued to the student.

In some embodiments, the plurality of nodes may include one or more achievement nodes corresponding to the one or more virtual achievements. Upon reaching each of the one or more achievement nodes, a record may be created in a virtual achievement database defining the corresponding virtual achievement. Placing the one or more virtual achievements in the metaverse instance may include accessing the virtual achievement database to identify the one or more records defining the one or more virtual achievements.

In some embodiments, the present invention may be implemented as a method for implementing workflows for supporting interactions across multiple learning environments and systems. A visual workflow editor may receive input that defines a plurality of nodes and interconnects the nodes to form a first workflow. The plurality of nodes may include a first achievement node and a metaverse node. The first workflow may be started for a student. Upon reaching the first achievement node, it may be determined that the first achievement node defines an achievement that should be made available to the student as a first virtual achievement. Upon reaching the metaverse node of the first workflow, a metaverse instance may be launched. The first virtual achievement may be placed in the metaverse instance.

In some embodiments, a record may be created in a virtual achievement database for the first virtual achievement. Placing the first virtual achievement in the metaverse instance may include accessing the virtual achievement database to locate the record.

In some embodiments, it may be determined that the student has located the first virtual achievement in the metaverse instance, and the record in the virtual achievement database may be updated.

In some embodiments, the metaverse instance may be terminated after a timer specified in the metaverse node has elapsed.

In some embodiments, the present invention may be implemented as one or more computer storage media storing computer executable instructions which when executed perform a method for implementing workflows for supporting interactions across multiple learning environments and systems. A first workflow may be started for a student. As part of executing an achievement node of the first workflow, it may be determined that the achievement node specifies that an achievement defined in the achievement node is to be made available to the student as a virtual achievement in a metaverse. A record representing the virtual achievement can be created. In response to executing a metaverse node of the first workflow, a metaverse instance can be launched for the student. The record can be accessed to identify the virtual achievement. The virtual achievement can be spawned in the metaverse instance.

In some embodiments, it may be determined that the student has located the virtual achievement in the metaverse instance and the achievement may be issued to the student.

In some embodiments, the metaverse instance may be terminated upon detecting that a play time specified in the metaverse node has elapsed.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

Understanding that these drawings depict only typical embodiments of the invention and are not therefore to be considered limiting of its scope, the invention will be described and explained with additional specificity and detail through the use of the accompanying drawings in which:

FIG. 1 illustrates an example computing environment in which one or more embodiments of the present invention may be implemented;

FIG. 2A-2H provide an example of how an admin can create a workflow using a visual-flow based model;

FIGS. 3A-3D provide an example of how a teacher may assign a workflow to one or more students;

FIGS. 4A-4D provide an example of how a student can participate in a workflow;

FIGS. 5A-5C provide an example of how AI nodes of a workflow can be used and handled;

FIG. 6 is a flow diagram representing how AI functionality can be provided when a student participated in a workflow;

FIGS. 7A and 7B provide another example of how AI nodes can be used in a workflow;

FIG. 8 provides an example of how an admin can create a workflow using a visual-flow based model where the workflow includes a metaverse node;

FIG. 9 provides an example of how a virtual achievement database can be leveraged to spawn virtual achievements in a metaverse;

FIG. 10 provides an example of how a virtual session database can be leveraged to control a student's access to a metaverse as part of completing a workflow; and

FIGS. 11A-11D provide an example of how a workflow having a metaverse node can be used to enable a student to access a metaverse.

### DETAILED DESCRIPTION

In this specification and the claims, the term “school” will be used to represent any educational or learning institute that may use a system that is configured in accordance with one or more embodiments of the present invention. The term “student” will be used to represent an individual that may attend or otherwise participate in a school for educational or learning purposes. The term “teacher” will be used to represent an individual that teaches at a school. The term “admin” will be used to represent an individual that administrates a system for a school. Students, teachers, and admins may be considered users of the system.

As an overview, embodiments of the present invention encompass a visual flow-based model for implementing workflows capable of supporting interactions spanning different learning environments and systems. These workflows can be considered quests for students to encourage the students to be more engaged in a learning environment. Embodiments of the present invention are focused on the underlying architecture and functionality that enable admins to create such workflows using a flow-based model (or diagram) which can then be translated into complex executable instructions and user interfaces that implement the workflows including to interact with teachers, students, parents, and external systems.

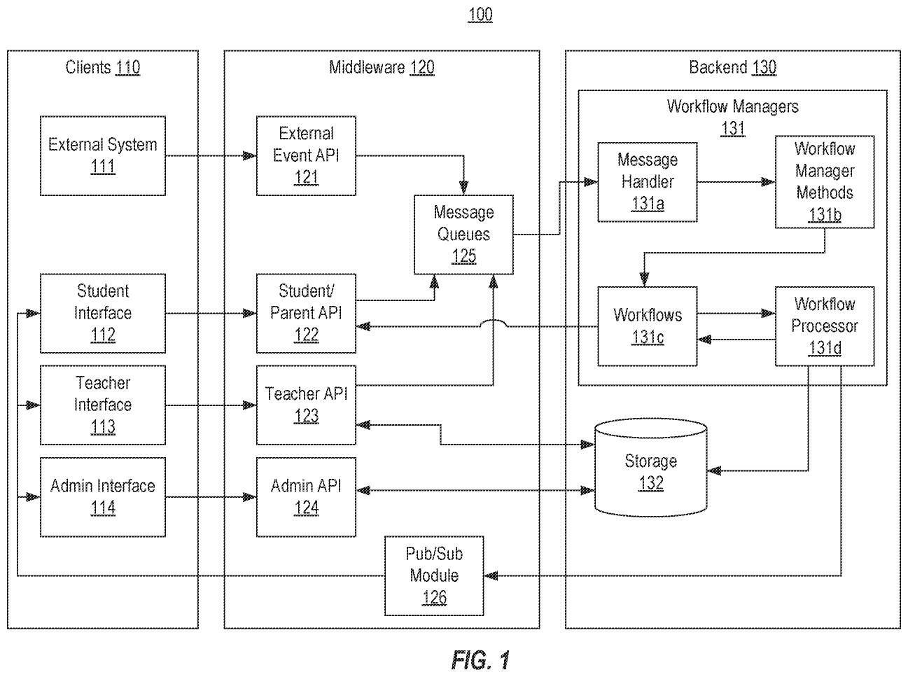

FIG. 1 provides an example of a computing environment 100 in which embodiments of the present invention may be implemented. Computing environment 100 can be logically divided into clients 110, middleware 120 and backend 130. Clients 110 can generally represent any computing device that users may use to access functionality of embodiments of the present invention such as desktops, laptops, tablets, smartphones, etc. Middleware 120 and backend 130 could be implemented in the cloud or on any arrangement of server computing devices/components.

Clients 110 may be used by students and parents to access a student interface 112, by teachers to access a teacher interface 113 and by admins to access an admin interface 114. Clients 110 may encompass one or more external systems 111 (e.g., third-party software solutions). Middleware 120 can include an external API 121, a student/parent API 122, a teacher API 123 and an admin API 124 which function as interfaces to external system 111, student interface 112, teacher interface 113 and admin interface 114 respectively for invoking functionality described herein. Middleware 120 can also include a number of message queues 125 for receiving and processing requests received from/via external event API 121, student/parent API 122 and teacher API 123. Middleware 120 can further include a publish/subscribe (pub/sub) module 126 that generally functions to provide workflow state change data to student interface 112, teacher interface 113 and admin interface 114 to thereby allow these components to update user interfaces in response to the state changes.

Backend 130 can encompass a number of workflow managers 131 (e.g., a workflow manager 131 for each student) and storage 132. Storage 132 can represent any suitable mechanism for storing the data described herein (e.g., one or more relational databases).

Each workflow manager 131 can include a message handler 131a that receives messages from message queue(s) 125 and handles them as described herein (e.g., to retrieve the entire state of workflow manager 131, to start a workflow, to trigger an event for an active workflow, to delete a workflow, etc.), workflow manager methods 131b that message handler 131a invokes as part of handling messages, one or more workflows 131c (or instances of workflow templates as may be updated as the workflows are executed as described herein), and a workflow processor 131d that processes workflows as described herein.

As stated above, every student can have a dedicated instance of workflow manager 131. As described herein, each instance of workflow manager 131 can be responsible for loading all of the student's workflows, processing requests received from message queues 125, executing methods of nodes of the active workflow, sending real-time results of the execution to student interface 112 (or other components as appropriate), waiting for events raised in response to input from the student, a parent, a teacher, an external system 111, etc., and persisting the state of each workflow. For example, storage 132 could include one or more data structures (e.g., relational tables) in which a student's data is maintained and the corresponding instance of workflow manager 131 could be loaded on demand from such data structures.

As described in further detail below, workflow processor 131d can be configured to convert a workflow template which may be in a text format into an object model consisting of nodes and connections. Workflow processor 131d can then process event values by sending such values to inputs of the nodes. When a node has all of its inputs defined, the node's executable method(s) can be executed to generate output values which in turn could function as inputs to connected node(s) and cause their execution.

Workflow processor 131d can implement a number of node methods which may be associated with particular types of nodes. These node methods can be configured to use inputs and parameter values that an admin may define using a visual flow-based model as described below to implement the logic of the nodes. Some node methods may be configured to immediately run to completion, while others may require external input (e.g., input from the student, a parent, a teacher, an external system, etc.) to complete. Node methods that require external input may subscribe to events indicative of such input that may be raised via external event API 121, student API 122, teacher API 123, etc. When such events occur, workflow manager 131 can load workflow processor 131d to execute the node method subscribed to such events to thereby resume the execution of the workflow.

As suggested above, in the context of the present invention, a workflow consists of interconnected nodes. Each node may include zero or more inputs, zero or more parameters and zero or more outputs. Each node may also be mapped to a node method in workflow processor 131d.

Various node types may exist such as activity nodes which can be used to require some type of event to occur, condition nodes which can be used to return an output when a condition is met, incentive nodes which can be used to reward a student in some manner, interaction nodes which can be used to generate a user interface for a student, parent, or teacher and may require interaction via the user interface, messaging nodes which can be used to post instructional content in a student's user interface and/or to send a message to a student or teacher, utility nodes which can be used to perform various types of events.

In some embodiments, some or all node types may provide artificial intelligence (AI) functionality. A node that provides AI functionality can be used to provide a chat (or other interactive) interface to a student by which the student may communicate with AI.

In some embodiments, a number of node types and nodes can be predefined and admins can be enabled to define additional nodes and/or node types. Each node can be defined in a manner that allows a visual representation of the node to be automatically generated as part of creating a workflow. For example, a node information JavaScript file (which could be stored in storage 132) could be used to store all nodes that have been created. Each node could include a node description (e.g., HTML) for rendering a visual representation of the node and a node definition (e.g., JavaScript code) that defines the nodes inputs, parameters and outputs. The following is an example of how a messaging type node named Send_Parent_Email and an interactions type node named Multiple_Choice could be described (in HTML) and defined (in JavaScript) within a “nodeInfo” JavaScript file. Notably, the “I”, “P” and “O” elements represent the inputs, parameters and outputs of the node.

```
nodeInfo: [
...
  { “cat”: “Messaging”, “id”: “Send_Parent_Email”, “lic”: [ ], “desc”: “Sends an email”,
“help”: “<div class=′nodehelp′> <div class=′info′> When this node is activated an email will be
sent to the students parent′s or guardians, if configured.</div> <div class=′sect′> <div
class=′ttl′>Inputs</div> <div class=′item′><b>Ready:</b> When an input is received the
email(s) are sent.</div> </div> <div class=′sect′> <div
class=′ttl′>Parameters</div><b>From:</b> Choose the teacher from which the email will be
sent from.</div> <div class=′item′><b>Subject:</b> The email subject.</div> <div
class=′item′><b>Message:</b> The body of the email.</div> </div> <div class=′sect′> <div
class=′ttl′>Outputs</div> <div class=′item′><b>Completed:</b> Sends output after the email
has been sent.</div><div class=′item′><b>No parent:</b> Sends output if the student doesn′t
have a parent or guardian.</div> </div> </div>“, “icon”:
“https://crittercoinweb.blob.core.windows.net/$web/img/NodeIco_p.png” },
  { “cat”: “Interactions”, “id”: “Multiple_Choice”, “lic”: [ ], “desc”: “Students can make
a choice”, “help”: “<div class=′nodehelp′> <div class=′info′>When this node is a multiple
choice question will be presented to the student. You can add as many asnwers as you want.
The selected answer will determine which output is triggered.</div> <div class=′sect′> <div
class=′ttl′>Inputs</div> <div class=′item′><b>Ready:</b> When an input is received the
question will be displayed in the Quest.</div> </div> <div class=′sect′> <div
class=′ttl′>Parameters</div> <div class=′item′><b>Question:</b> Enter the question for
which you want the student to respond.</div> </div> <div class=′sect′> <div
class=′ttl′>Outputs</div> <div class=′item′><b>Answer x:</b> Add as many answers as you
would like. Enter the text response into each answer.</div> </div> </div>“, “icon”:
“https://crittercoinweb.blob.core.windows.net/$web/img/NodeIco_b.png” },
...
]
...
Send_Parent_Email: {
  “title”: “Email Parents”,
  “x”: 0,
  “y”: 0,
  “options”: [ ],
  “HasRun”: false,
  “Success”: false,
  “ErrorMsg”: “NULL”,
  “bc”: “rgba(222, 138, 215, 0.95)”,
  “w”: 300,
  “i”:
    [
      { “id”: “Ready”, “t”: staticNodeEditor.const_string, “v”: “NULL” },
    ],
  “p”:
    [
      { “id”: “Teacher”, “ctl”: staticNodeEditor.const_singleteacher_selector, “1”:
  “From”, “t”: staticNodeEditor.const_string, “v”: “NULL” },
      { “id”: “Subject”, “ctl”: staticNodeEditor.const_textbox, “l”: “Subject”, “t”:
  staticNodeEditor.const_string, “v”: “NULL” },
      { “id”: “Message”, “ctl”: staticNodeEditor.const_multiline, “l”: “Message”,
  “t”: staticNodeEditor.const_string, “v”: “NULL” },
    ],
  “o”:
    [
      { “id”: “Sent”, “sort”: 1, “ctl”: ““, “l”: “Completed”, “t”:
  staticNodeEditor.const_bool, “v”: “NULL” },
      { “id”: “NoParent”, “sort”: 2, “ctl”: ““, “l”: “No parent”, “t”:
  staticNodeEditor.const_bool, “v”: “NULL” },
    ]
},
Multiple_Choice: {
  “title”: ““,
  “x”: 0,
  “y”: 0,
  “options”: [staticNodeEditor.const_allow_add_outputs,
  staticNodeEditor.const_allow_delete_outputs],
  “HasRun”: false,
  “Success”: false,
  “ErrorMsg”: “NULL”,
  “bc”: “rgba(0,204,255,0.95)”,
  “w”: 300,
  “i”:
    [
      { “id”: “Ready”, “t”: staticNodeEditor.const_bool, “v”: “NULL” }
    ],
  “p”:
    [
  { “id”: “Question”, “ctl”: staticNodeEditor.const_textbox, “l”: “Question”, “t”:
  staticNodeEditor.const_string, “v”: “NULL” }
    ],
  “oTitle”: “Choices”,
  “o”:
    [
      { “id”: “Answer-1”, “sort”: 1, “ctl”: staticNodeEditor.const_textbox, “l”: ““,
  “t”: staticNodeEditor.const_string, “v”: “NULL” },
      { “id”: “Answer-2”, “sort”: 2, “ctl”: staticNodeEditor.const_textbox, “l”: ““,
  “t”: staticNodeEditor.const_string, “v”: “NULL” },
    ]
},
...
```

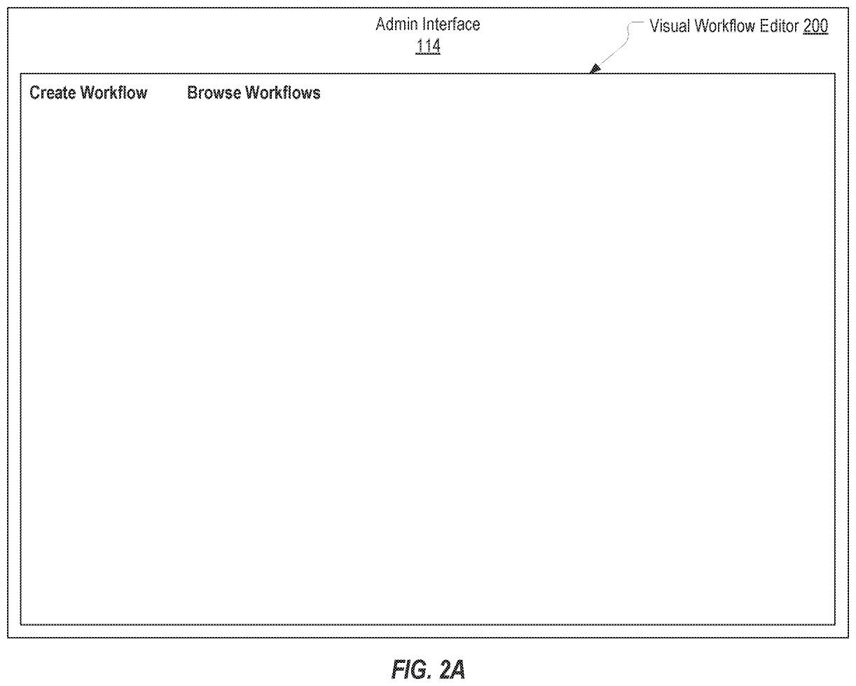

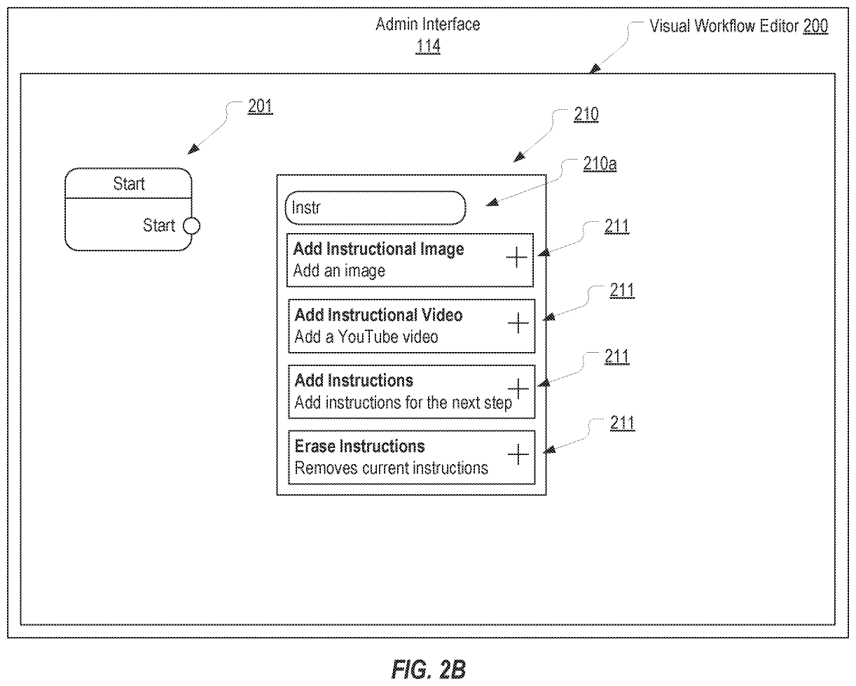

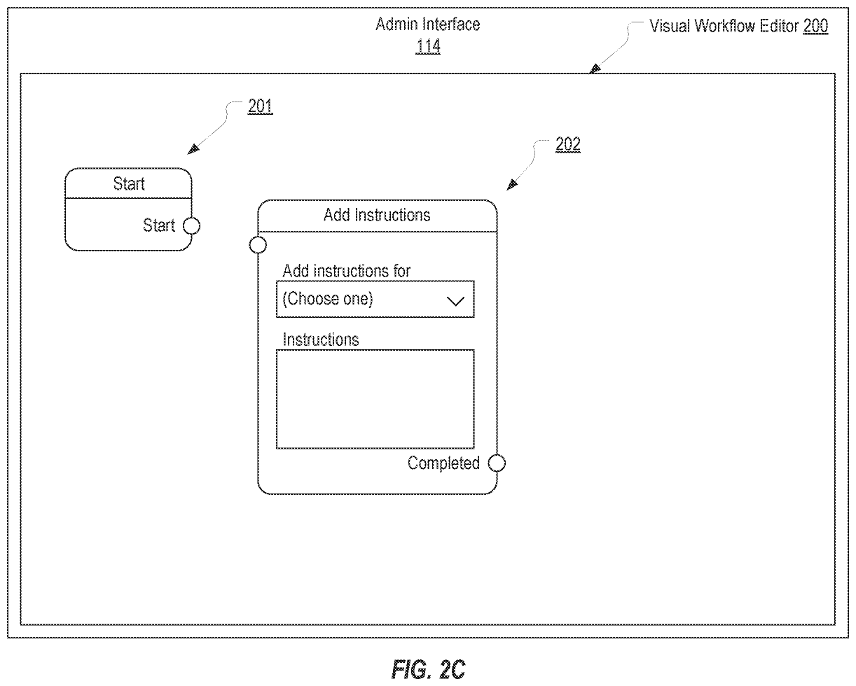

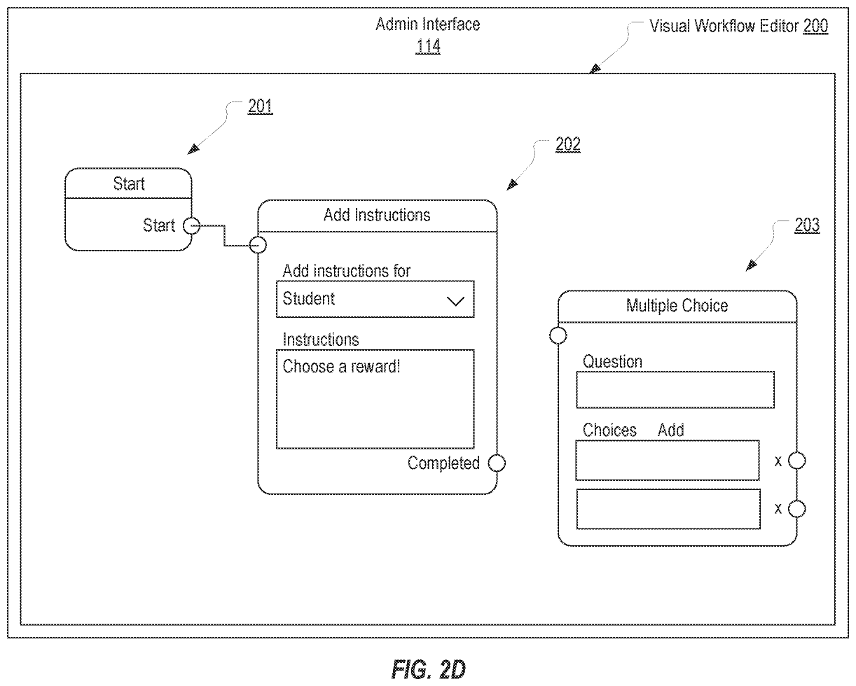

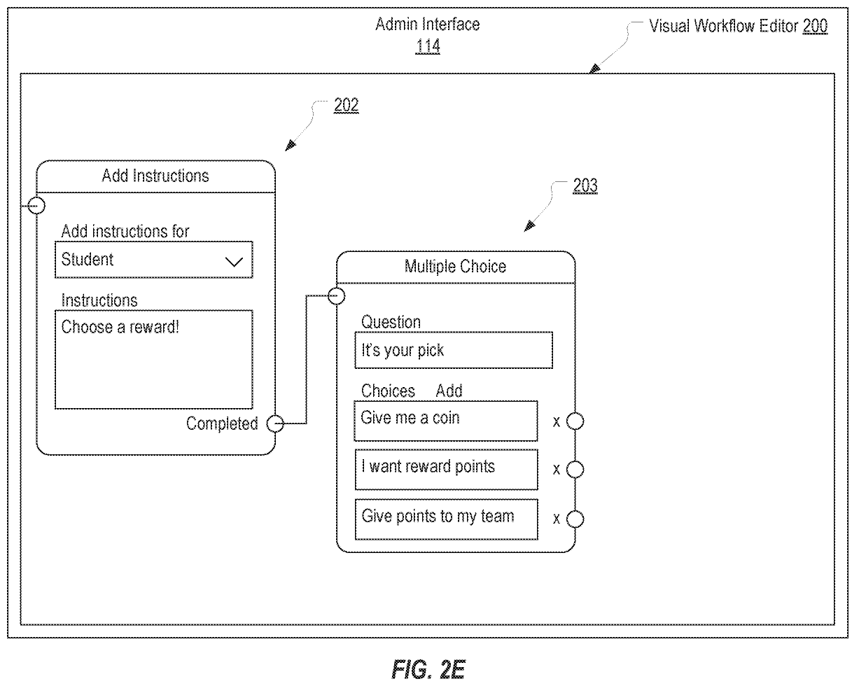

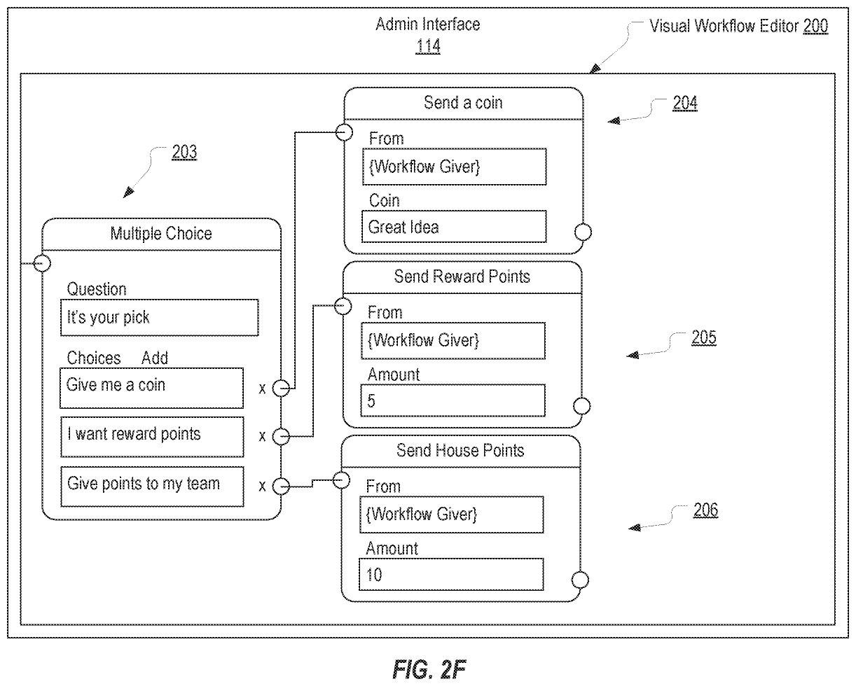

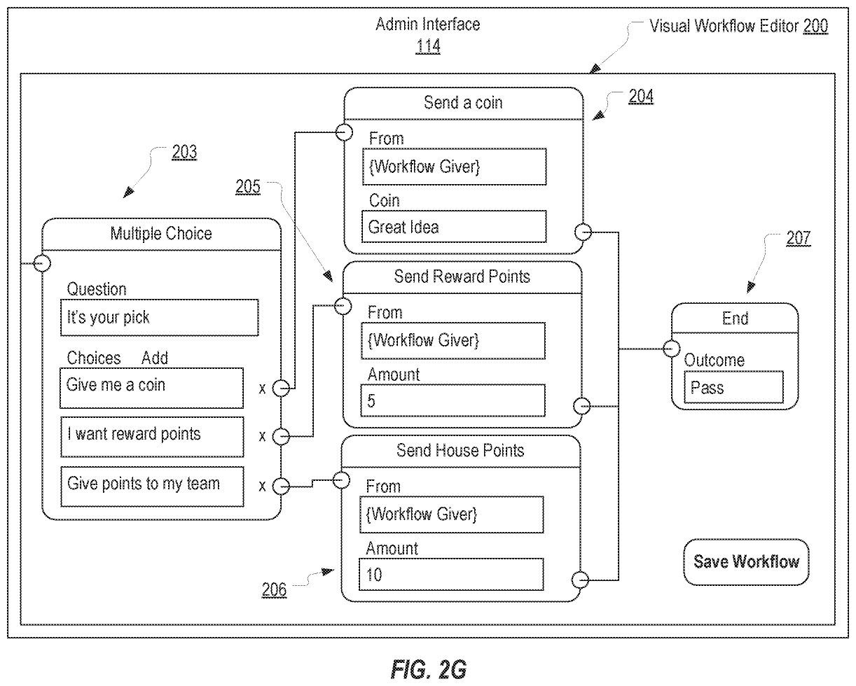

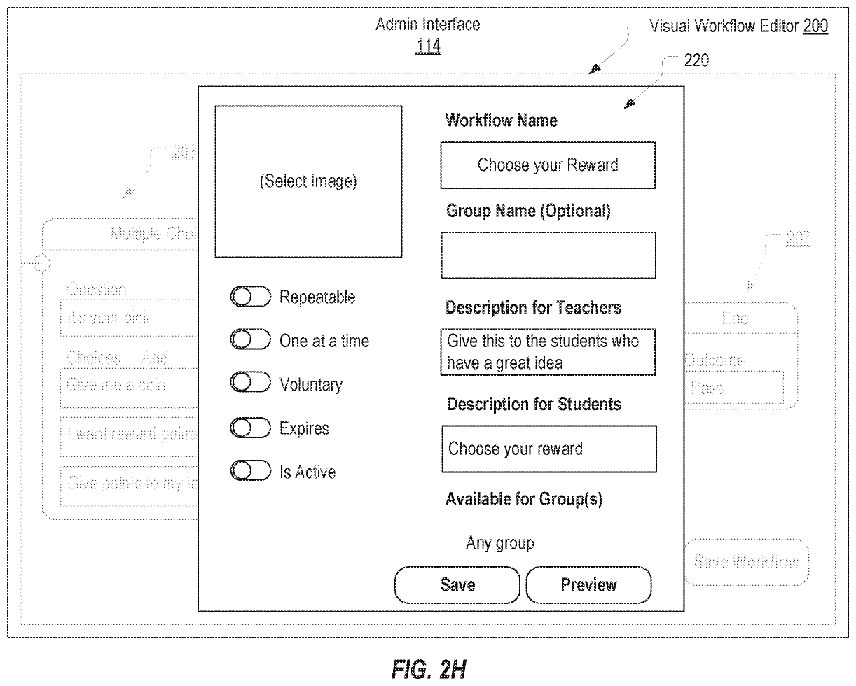

In some embodiments, admin interface 114 can enable admins to access a visual workflow editor in which the admins can view, modify, and create workflows. FIGS. 2A-2H provide an example of how an admin can access a visual workflow editor 200 via admin interface 114 to create a workflow. In FIG. 2A, it is assumed that the admin has accessed visual workflow editor 200 and is presented with the options of creating a workflow and browsing existing workflows.

Turning to FIG. 2B, it is assumed that the admin has selected the option to create a workflow, and in response, visual workflow editor 200 added a start node 201 to visual workflow editor 200. As shown, start node 201 includes the title “Start” and a single output named “Start.” In the depicted example, inputs and outputs of a node are visually represented as circles on the left and right sides respectively of the node.

It is also assumed that the admin has invoked a node adder window 200a (e.g., by right clicking on visual workflow editor 200) and has typed “instr” into a search box 210a as part of an attempt to locate existing nodes that include “instruction” in their names. Node adder window 200a is shown as including four node representations 211 that match the search and that include an option (+) to add the respective node to the current workflow.

Turning to FIG. 2C, it is now assumed that the admin has selected the node representation 211 for the Add Instructions node, and as a result, the Add Instructions node 202 has been added to the workflow within visual workflow editor 200. Visual workflow editor 200 can render the Add Instructions node 202 (and any other selected node) by accessing the description and definition of the node maintained in storage 132. Importantly, the rendering of the Add Instructions node 202 includes creating a representation of a single input, two parameters (the “Add instructions for” parameter which is a selector that will allow the selection of a user type to whom the instructions will be targeted and the “Instructions” parameter which is a text box for allowing the input of instructions), and a single output. At this point, the Add Instructions node 202 is not yet interconnected with the start node 201 (or any other node).

Turning to FIG. 2D, it is now assumed that the admin interconnected the output of the start node 201 with the input of the Add Instructions node 202 to thereby define that the workflow should proceed from the start node 201 to the Add Instructions node 202. It is also assumed that the admin has selected “Student” as the user type that is the target of the instructions and has typed in “Choose a reward!” as the instructions. It is further assumed that the admin has again invoked the node adder window 200a and used it to select the Multiple Choice node 203 to be added to the current workflow. As shown, the Multiple Choice node 203 includes a single input, a question parameter, two choices parameters with the option to add more choices, and two outputs corresponding to the two choices parameters.

Turning to FIG. 2E, it is now assumed that the admin interconnected the output of the Add Instructions node 202 to the input of the Multiple Choice node 203, added “It's your pick” to the question parameter, adding a third choice, and defined the three choices as “Give me a coin,” “I want reward points,” and “Give points to my team.”

Turning to FIG. 2F, it is now assumed that the admin has used the node adder window 200a to add a Send a coin node 204, a Send Reward Points node 205, and a Send House Points node 206, has connected their inputs with the corresponding outputs of Multiple Choice node 203, and has populated the parameters of these three nodes ({Workflow Giver} can represent a user that will be determined at the time the workflow is executed).

Turning to FIG. 2G, it is now assumed that the admin has used the node adder window 200a to add an end node 207 to the workflow and has connected the outputs of nodes 204-206 to the input of end node 207 thereby completing the creation of the workflow. End node 207 also includes a parameter for defining the outcome of the workflow (e.g., pass or fail). With start and end nodes added, the inputs and outputs of all nodes interconnected, and all parameters defined, the workflow is complete and can be saved.

Turning to FIG. 2H, it is assumed that the admin has selected to save the workflow which has caused window 220 to appear. Window 220 allows the admin to provide a name and image for the workflow, an optional name for a group to which the workflow pertains, a description for teachers, a description for students, and indication of student groups to which the workflow will be available, and a number of configuration settings such as whether the workflow is repeatable (whether students can perform the workflow more than once), can only be done one at a time (whether a student can have more than one active instance of the workflow), is voluntary (whether students can start the workflow themselves rather than requiring that a teacher assign the workflow), expires (whether the workflow should automatically complete with a fail status at a specified future time), and is active (whether the workflow should be available for use).

When the admin has created the workflow in visual workflow editor 200, a corresponding workflow template can be stored (e.g., in storage 132) which defines the workflow. The following is an example of a workflow template for a simple workflow that includes a start node, a Send a Coin node with From, Coin and Comment parameters and an end node.

```
{
  “id”: ““
  “templateID”: “70c7b56c-dbfd-4cfe-bcfc-e211b6b5c86c”,
  “nodes”: [
    {
      “IsActive”: false,
      “HasRun”: false,
      “Success”: false,
      “ErrorMsg”: “NULL”,
      “title”: null,
      “bc”: “rgba(204,204,0,0.95)”,
      “w”: 120,
      “i”: [
      ],
      “p”: [
      ],
      “o”: [
        {
          “id”: “Ready”,
          “ctl”: “readonly”,
          “l”: “Start”,
          “t”: “bool”,
          “v”: “1”
        }
      ],
      “type”: “Start”,
      “id”: “06b94371-d999-4146-9dd2-fdf12478d846”,
      “x”: 32,
      “y”: 32,
      “z”: 0,
      “count”: 0,
      “finished”: false
    },
    {
      “IsActive”: false,
      “HasRun”: false,
      “Success”: false,
      “ErrorMsg”: “NULL”,
      “title”: “Send a Coin”,
      “bc”: “rgba(153,204,51, 0.95)”,
      “w”: 300,
      “i”: [
        {
          “id”: “Ready”,
          “t”: “string”,
          “v”: “NULL”
        }
      ],
      “p”: [
        {
          “id”: “Teacher”,
          “ctl”: “singleteacherselector”,
          “l”: “From”,
          “t”: “string”,
          “v”: “{Quest Giver}”,
          “opt”: null,
          “max”: 0
        },
        {
          “id”: “CoinName”,
          “ctl”: “coinselector”,
          “l”: “Coin”,
          “t”: “string”,
          “v”: “Great Idea”,
          “opt”: null,
          “max”: 0
        },
        {
          “id”: “Comment”,
          “ctl”: “multiline”,
          “l”: “Comment (optional)”,
          “t”: “string”,
          “v”: “That was a very helpful idea!”,
          “opt”: “true”,
          “max”: 500
        }
      ],
      “o”: [
        {
          “id”: “Completed”,
          “ctl”: ““,
          “l”: “Completed”,
          “t”: “bool”,
          “v”: “NULL”
        }
      ],
      “type”: “Send_Coin”,
      “id”: “b6d99367-1221-4ccd-b2bb-47e0b62071b1”,
      “x”: 280,
      “y”: 37,
      “z”: 10000002,
      “count”: 0,
      “finished”: false
    },
    {
      “IsActive”: false,
      “HasRun”: false,
      “Success”: false,
      “ErrorMsg”: “NULL”,
      “title”: “End”,
      “bc”: “rgba(204,204,0,0.95)”,
      “w”: 200,
      “i”: [
        {
          “id”: “Ready”,
          “t”: “string”,
          “v”: “NULL”
        }
      ],
      “p”: [
        {
          “id”: “Outcome”,
          “ctl”: “passfail”,
          “l”: “Outcome”,
          “t”: “string”,
          “v”: “NULL”,
          “opt”: null,
          “max”: 0
        }
      ],
      “o”: [
      ],
      “type”: “End”,
      “id”: “150c4a24-2e54-40f1-8bc4-b4f8850a301e”,
      “x”: 725,
      “y”: 281,
      “z”: 10000002,
      “count”: 0,
      “finished”: false
    }
  ],
  “connections”: [
    {
      “fromNode”: “06b94371-d999-4146-9dd2-fdfl2478d846”,
      “fromOutput”: “Ready”,
      “toNode”: “b6d99367-1221-4ccd-b2bb-47e0b62071b1”,
      “toInput”: “Ready”
    },
    {
      “fromNode”: “b6d99367-1221-4ccd-b2bb-47e0b62071b1”,
      “fromOutput”: “Completed”,
      “toNode”: “150c4a24-2e54-40fl-8bc4-b4f8850a301e”,
      “toInput”: “Ready”
    }
  ],
  “created”: 0,
  “updated”: 0
}
```

As described in detail below, a workflow template can be serialized to an object model that workflow processor 131d may use to execute the workflow and the object model may be deserialized back to the workflow template to persist updates to the workflow. In some embodiments, admin interface 114 may provide a mechanism to allow the admin to preview/test workflows (e.g., to interface with the workflows as if the admin were a student). In some embodiments, this testing may be accomplished by auto-generating a test student account for the admin with which the admin can test the workflow.

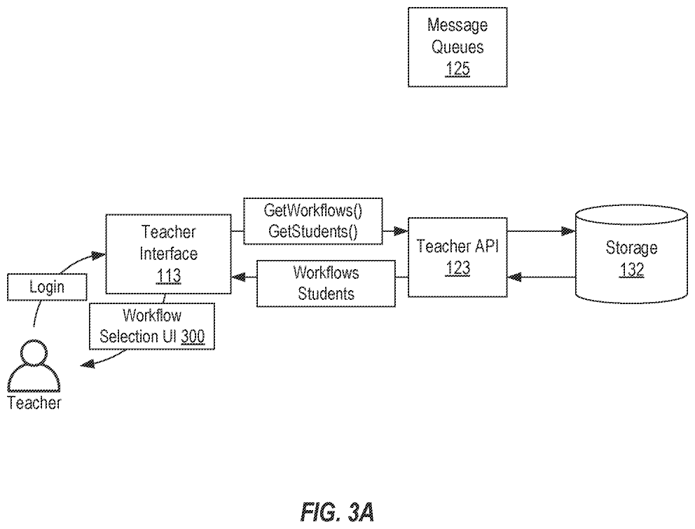

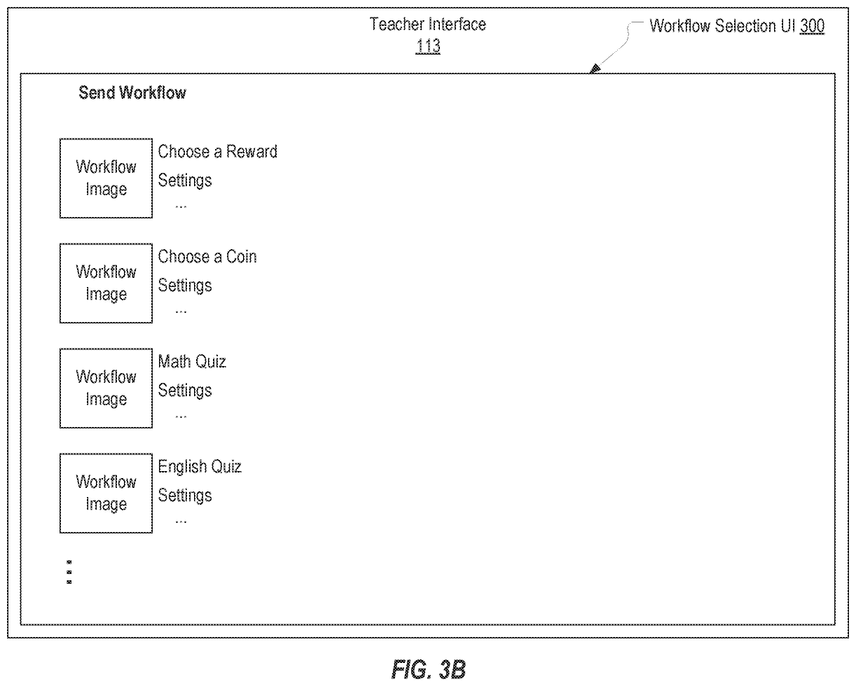

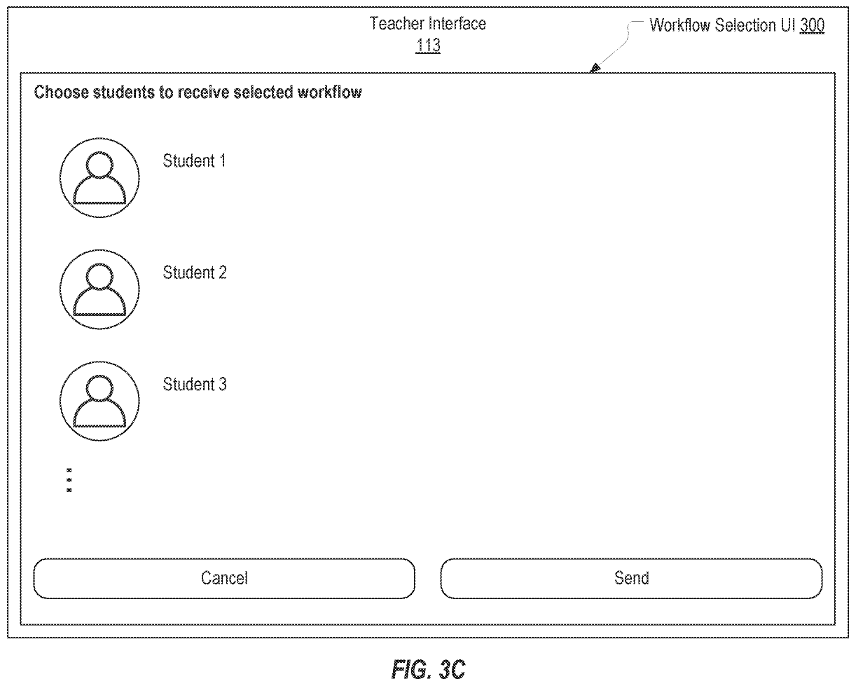

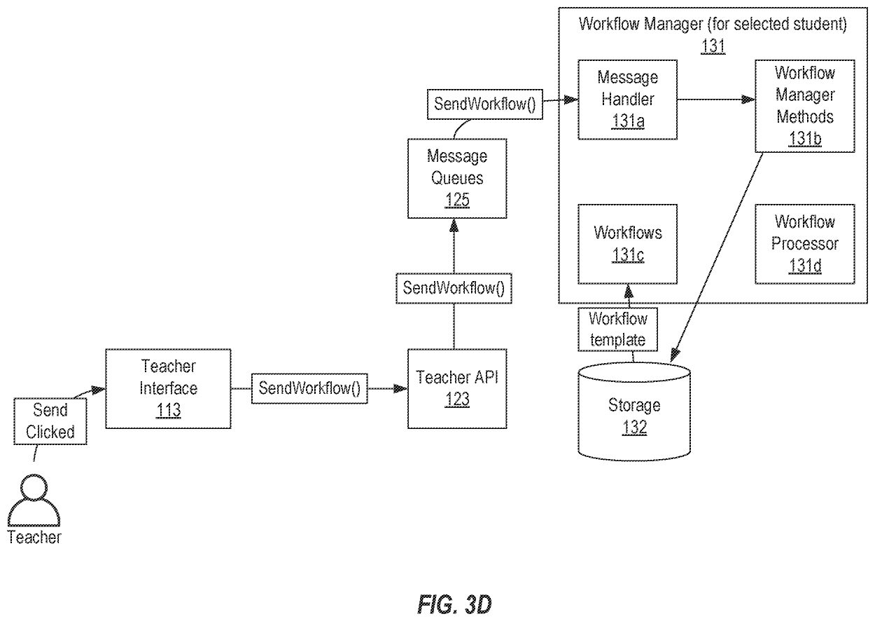

FIGS. 3A-3D provide an example of how a teacher may assign a workflow to one or more students. For purposes of this example, it is assumed that the “Choose your Reward” workflow from FIGS. 2A-2H has already been created and is stored (or more accurately, the corresponding workflow template is stored) in storage 132.

Turning to FIG. 3A, a teacher is shown as logging in via teacher interface 113. In conjunction with this login, teacher interface 113 can invoke teacher API 123 to get all workflows that are available to this teacher and to get all students of this teacher (e.g., by making calls to a GetWorkflows( ) and GetStudents( ) API of teacher API 123). Teacher interface 113 can then display a workflow selection user interface 300 by which the teacher can select a workflow and one or more students to whom the workflow should be sent.

FIG. 3B provides an example of how workflow selection user interface 300 may appear. As shown, workflow selection user interface 300 may display a representation of each workflow that the teacher may send to a student. In this example, it is assumed that the teacher selects the Choose a Reward workflow which causes workflow selection user interface 300 to update to display the students to whom the selected workflow can be sent as shown in FIG. 3C. It is also assumed that the teacher selects only Student 1 and then clicks the send button.

Turning to FIG. 3D, and in response to the teacher's input to send the Choose a Reward workflow to Student 1, teacher interface 113 can interface with teacher API 123 to request that the workflow be sent to Student 1 (e.g., by calling SendWorkflow( ) and identifying the Choose a Reward workflow and Student 1). Teacher API 123 may then send a corresponding message to message queue 125, and message queue 125 can determine that the message pertains to Student 1 and can therefore locate the instance of workflow manager 131 that pertains to Student 1. Message queue 125 can then pass the message to message handler 131a within the instance of workflow manager 131. Message handler 131a could then invoke workflow manager methods 131b (e.g., by invoking a method for sending workflows). Workflow manager methods 131b could then access storage 132 to obtain the workflow template for the workflow to be sent and add the workflow template to workflows 131c. At this point, the Choose a Reward workflow is assigned to Student 1 because its workflow template is part of workflows 131c. Although not shown, workflow manager 131 could cause a notification to be immediately sent to Student 1 informing him or her that the Choose a Reward workflow has been assigned. Alternatively, such a notification could be provided when Student 1 next logs in to student interface 112.

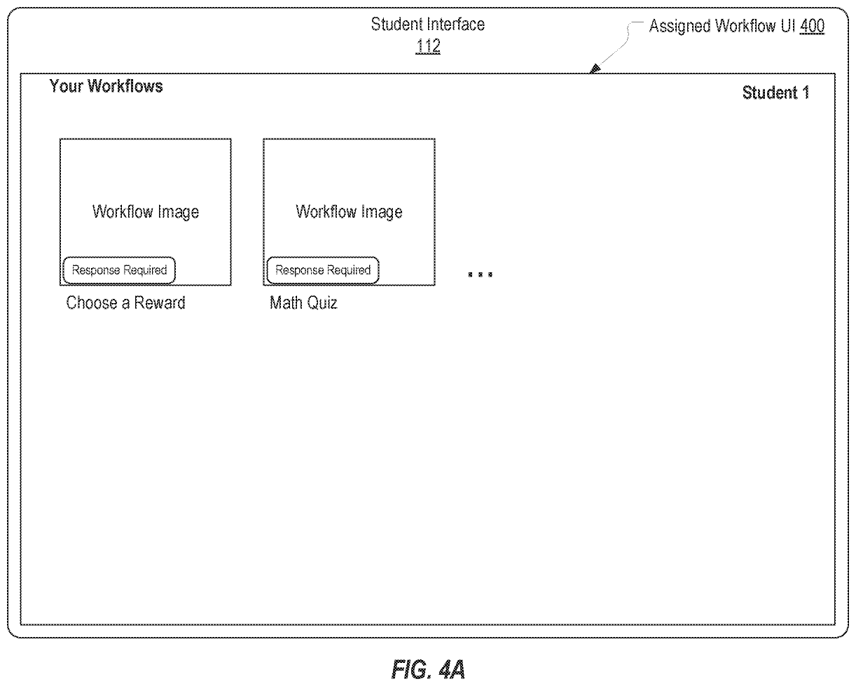

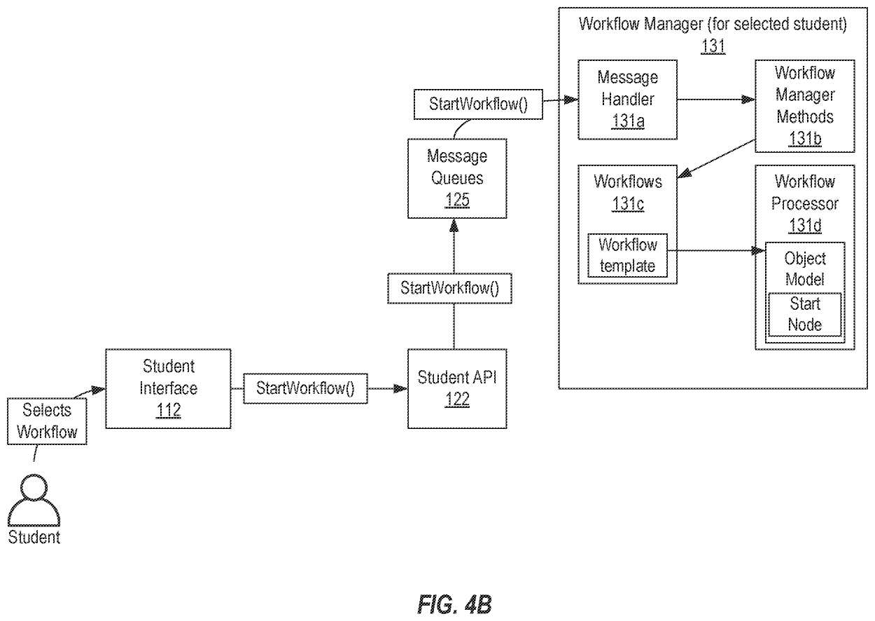

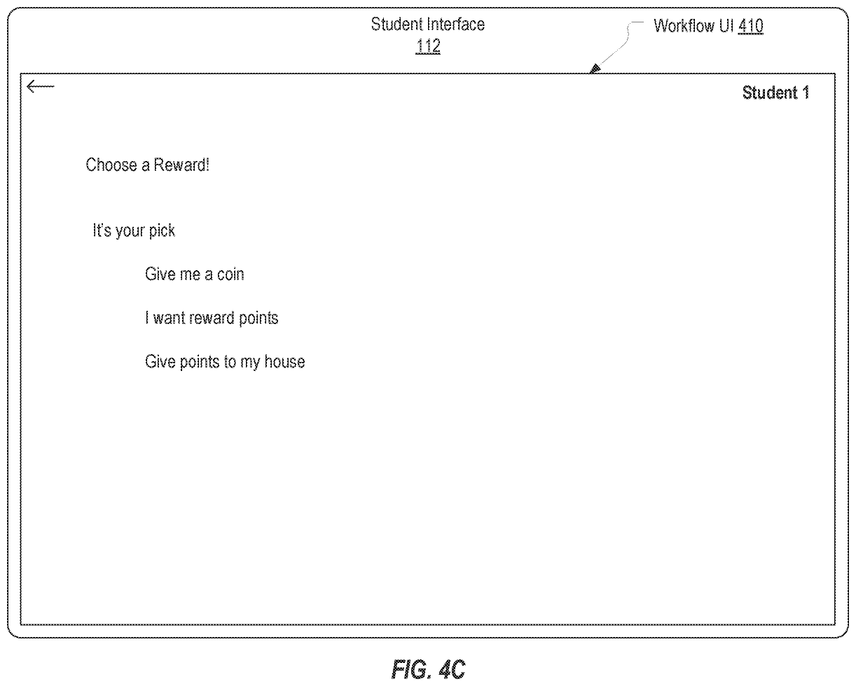

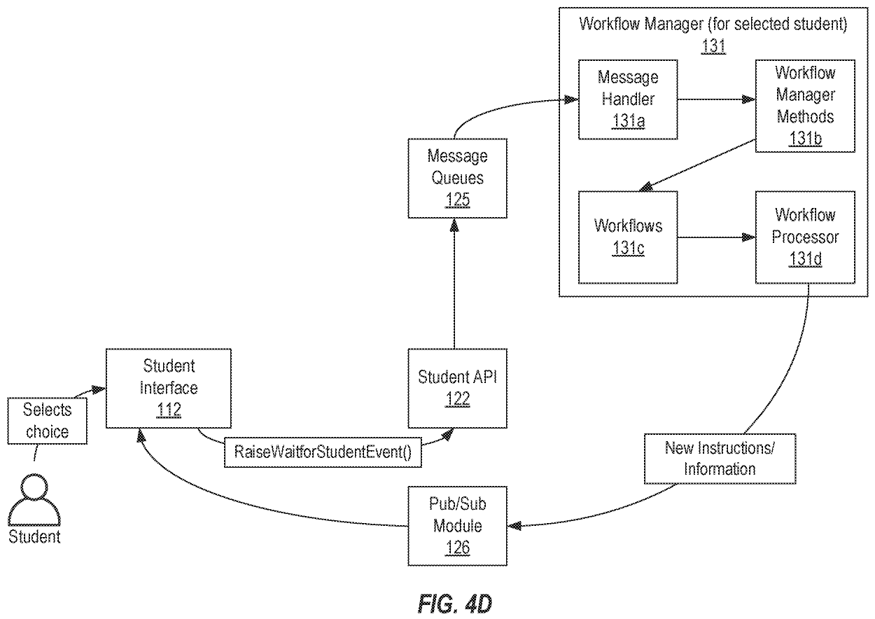

FIGS. 4A-4D provide an example of how a student can participate in a workflow. This example will also be based on the Choose a Reward workflow.

Turning to FIG. 4A, student interface 112 is shown as providing an assigned workflow user interface 400 to Student 1 to thereby show Student 1 each workflow that a teacher has assigned. Workflow user interface 400 shows that the Choose a Reward workflow has been assigned. For example, when the student logs in via student interface 112, student API 123 can query workflow manager 131 (or storage 132) to identify workflows 131c and then populate assigned workflow user interface 400 with a representation of each of workflows 131c.

Turning to FIG. 4B, it is assumed that the student selects the representation of the Choose a Reward workflow within assigned workflow user interface 400. Student interface 112 could then interface with student API 122 to request that the workflow be started (or resumed if the workflow has already been started but not completed). Student API 122 could pass a corresponding message to message queue 125 which in turn could pass the message to message handler 131a. Message handler 131a could then invoke workflow manager methods 131b to cause the Choose a Reward workflow to be started. The starting of the Choose a Reward workflow may entail deserializing the workflow template to an object model that workflow processor 131d can execute. Workflow processor 131d can then proceed to execute each node of the workflow in order until reaching a node that does not have all of its inputs defined. For example, with reference to FIG. 2D, workflow processor 131d can execute the start node 201 to simply determine which node is connected to the start node 201's output which in this case is the Add Instructions node 202. Workflow processor 131d can then determine that the add Instructions node 202 does not have any undefined inputs and can therefore execute it. This execution would entail interfacing with student interface 122 (e.g., via pub/sub module 126) to cause it to display a window that includes the instructions “Choose a reward!” Workflow processor 131d would then determine that the output of the Add Instructions node 202 is connected to the input of the Multiple Choice node 203 and that the Multiple Choice node 203 does not have any undefined inputs. Workflow processor 131d would then proceed to execute the Multiple Choice node 203 by interfacing with student interface 122 to cause the question and choices shown in FIG. 2E to be added to the window. Then, workflow processor 131d would determine that the output of the Multiple Choice node 203 is not yet defined and could pause the execution of the workflow to wait for the student to provide the necessary input (which in this case is input that selects a choice). This waiting can entail subscribing with workflow manager 131 for an event indicative of the required input.

After this execution of the nodes of the Choose a Reward workflow, student interface 122 may present a workflow user interface 410 as shown in FIG. 4C that includes the instruction from the Add Instructions node 202 and the question and selectable choices from the Multiple Choice node 203.

Turning to FIG. 4D, it is assumed that the student selects one of the three choices within workflow user interface 410. In response to this selection, student interface 112 can interface with student API 122 to raise an event indicative of student input and can identify the workflow, the student and the input. This in turn will lead to workflow processor 131d being notified of the event and then invoking a method to handle the event which in this case will set the value of the outputs of the Multiple Choice node 203. Notably, in some instances, the workflow may be serialized back to workflows 131c as part of waiting for an event to be raised, and in such cases, the workflow could be deserialized back to the object model as part of handling the event when it occurs. This serializing and deserializing of workflows can enable a large number of workflow managers 131 to be concurrently hosted thus allowing a large number of students to concurrently use the system.

Upon receiving the student's choice as part of the raised event, workflow processor 131d can determine that the output corresponding to the selected choice (which is assumed to be “Give me a coin”) is connected to the input for node 204 and that all of node 204's inputs are defined. Workflow processor 131d can then execute node 204 by awarding the “Great idea” coin to the student (with the teacher that assigned the workflow as the giver of the coin). This awarding of the coin could include interfacing with student interface 122 (e.g., via pub/sub module 126) to notify the student that the coin has been awarded (e.g., by erasing the previously presented instructions, question and answers and adding new instructions/information). Workflow processor 131d can also determine that the output of node 204 is known and therefore proceed to execute the end node 207 thereby leading to the successful completion of the workflow. In some embodiments, when a student completes a workflow, workflow manager 131 may update workflows 131c to remove the completed workflow.

Throughout the above-described process, the state of the Choose a Reward workflow can be updated and maintained within workflows 131c (e.g., by updating the workflow template). Accordingly, at any time, the instance of the Choose a Reward workflow that is assigned to the student can be resumed/recreated from workflows 131c within the instance of workflow manager 131 that pertains to the student.

In some embodiments, a UI presented to a student may be dynamically generated using instructional nodes which insert text, images, video references, etc. into an ordered list as the nodes are executed. For example, when a workflow includes instructional nodes, workflow processor 131d can create an ordered list that includes the content specified in the nodes and may then send the ordered list to student interface 112 (e.g., via pub/sub module 126). Student interface 112 may then generate the student's UI dynamically in accordance with the ordered list such that the content listed first in the ordered list is rendered towards the top of the UI and the subsequent content in the ordered list is then rendered below. In some cases, the content in the ordered list may be associated with a pinned parameter which when set causes the content to remain in the UI even when workflow processor 131d sends an instruction to erase the content of the displayed UI.

In some embodiments, workflow processor 131d may subscribe to events in conjunction with causing interactive UI elements to be rendered in the student's UI. For example, if workflow processor 131d executes a node that is configured to generate a button, workflow processor 131d can subscribe to an event indicative of the button being pressed. In such cases, workflow processor 131d can cause the button to be associated with a call to student API 121 that will raise the event. Then, once the button is rendered and the button is clicked, student API 121 will be invoked to generate the event to which workflow processor 131d is subscribed. Upon receiving the event, workflow processor 131d can automatically unsubscribe from the event thereby causing the button to be dynamically removed from the student's UI. In this way, such interactive UI elements can be dynamically generated in the student UI while ensuring that their configuration automatically invokes the appropriate methods of workflow processor 131d.

Some workflows may include one or more nodes that require input from a user other than the student to whom the workflow is assigned. For example, a workflow may include a node that requires the student to provide input, such as confirmation of having completed a task, and may then include a node that requires a parent or teacher to provide input, such as confirmation that the student completed the task. Workflow processor 131d can handle such workflows in a similar manner as described above. For example, upon reaching a node that requires input from a parent (or a teacher), workflow processor 131d can send a notification (e.g., an email) that includes content (e.g., a link, QR code, etc.) that can be selected to invoke student/parent API 122 (or teacher API 123) to raise an appropriate event indicative of the parent's (or teacher's) input. The event could be routed to workflow processor 131d as described above and then processed to complete the node of the workflow.

Similarly, some workflows may include one or more nodes that require input from an external system 111. For example, an external system 111 could be another educational software system that the student uses to complete a task required by a node of an assigned workflow. In such cases, external system 111 can be configured to leverage external event API to raise an event indicative of the student's completion of the task, and such events can be handled as described above.

As mentioned above, a workflow could be configured as voluntary. In such cases, student interface 112 may be configured to present the workflow to the student even though a teacher has not sent it. For example, with reference to FIG. 4A, student interface 112 could include in assigned workflow UI 400 (or another UI) an option to view any workflows that are voluntary. If the student selects a voluntary workflow, the workflow can be started and executed in the same manner as described above.

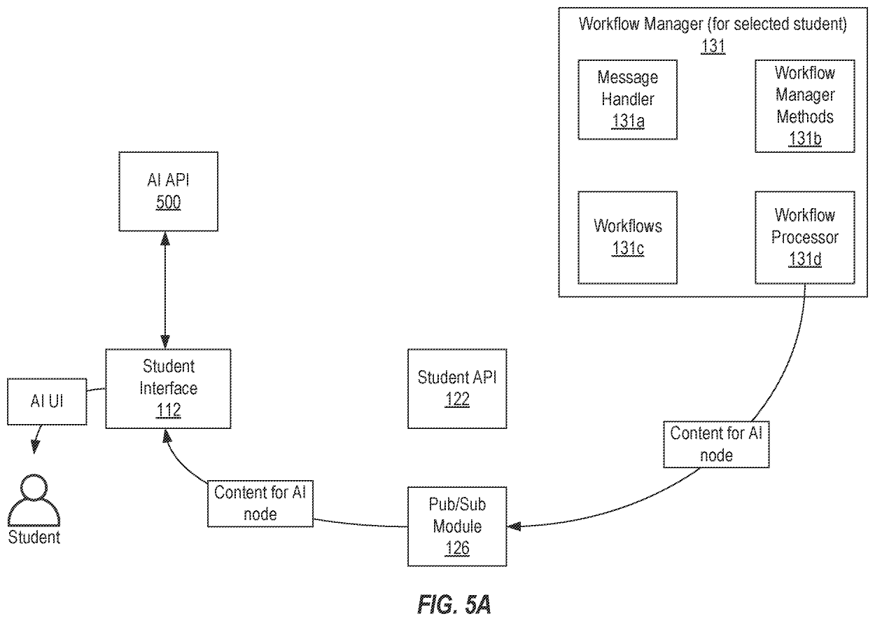

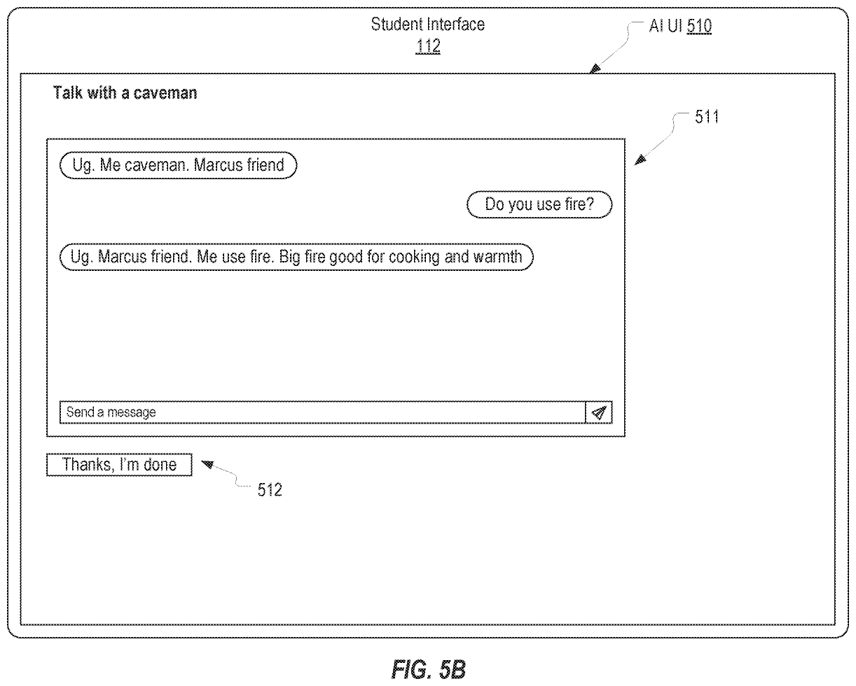

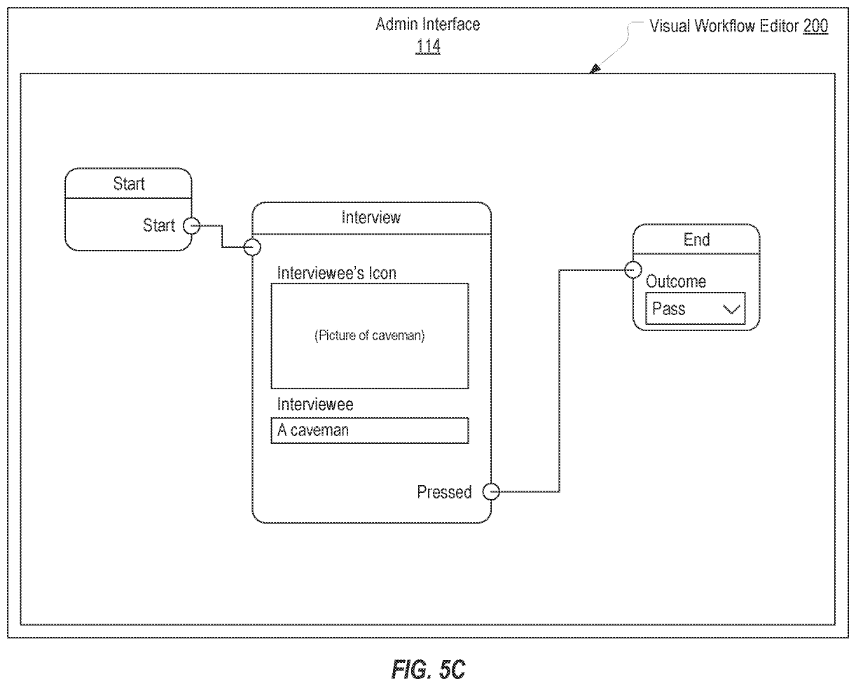

FIGS. 5A and 5B provide an example of how workflows having nodes that provide AI functionality (an “AI node”) can be handled in accordance with embodiments of the present invention. Workflow processor 131d can generally handle AI nodes in a similar manner as described above. For example, with reference to FIG. 5A, upon reaching an AI node, workflow processor 131d can identify the content that should be presented to the student via student interface and can send such content (or instructions for rendering such content) to student interface 112 via pub/sub module 126. Upon receiving such content, student interface 112 can render an AI UI 510, such as is shown in FIG. 5B, and can also interface with an AI API 500 to incorporate AI functionality within AI UI 510.

Turning to FIG. 5B, it is assumed that the AI node of the workflow is configured to provide a chat interface (e.g., as shown in FIG. 5C) by which the student can interact with an AI caveman and therefore student interface 112 renders AI UI 510 to include a chat interface 511 and a button 512 for ending the chat. Student interface 112 can use AI API 500 to establish a session with an AI service (not shown) and can populate chat interface 511 with the student's and AI caveman's communications. When the student is finished chatting with the AI cavemen, he or she can select button 512. In response, student interface 112 can invoke student API 122 to raise an event indicative of the completion of the AI session which can be routed in a similar manner as the above-described events to cause workflow processor 131d to complete the execution of the AI node and move on to the next node of the workflow (unless further input is required to complete the execution of the AI node).

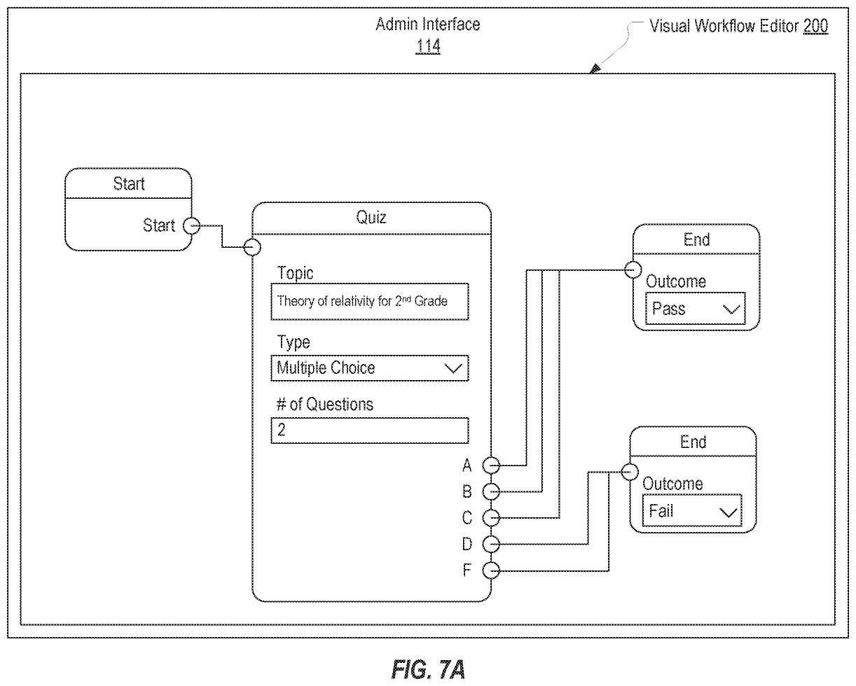

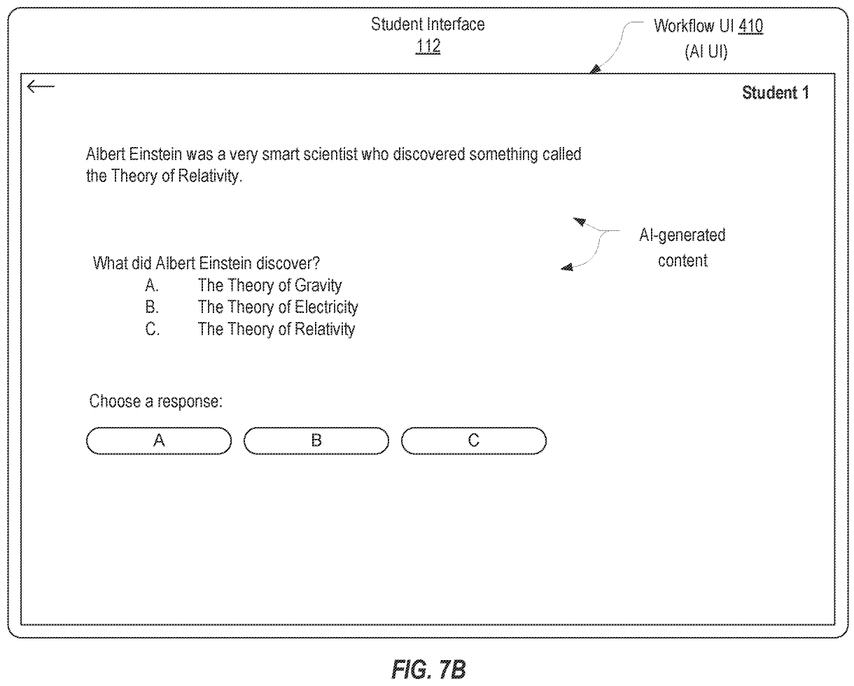

This type of AI functionality could also be used to provide an AI-based quiz or test to a student such as is represented in FIGS. 7A and 7B. For example, an AI node could be configured to provide a multiple question quiz to a student on a particular subject. In such cases, the configuration of the AI node will not define the questions or answers but will rely on AI to generate them. The rendering of UI presented to the student could be performed in a similar manner as with the chat-based UI except that student interface 112 may leverage AI API 500 to retrieve the questions and answers for the particular subject and may populate them into the UI.

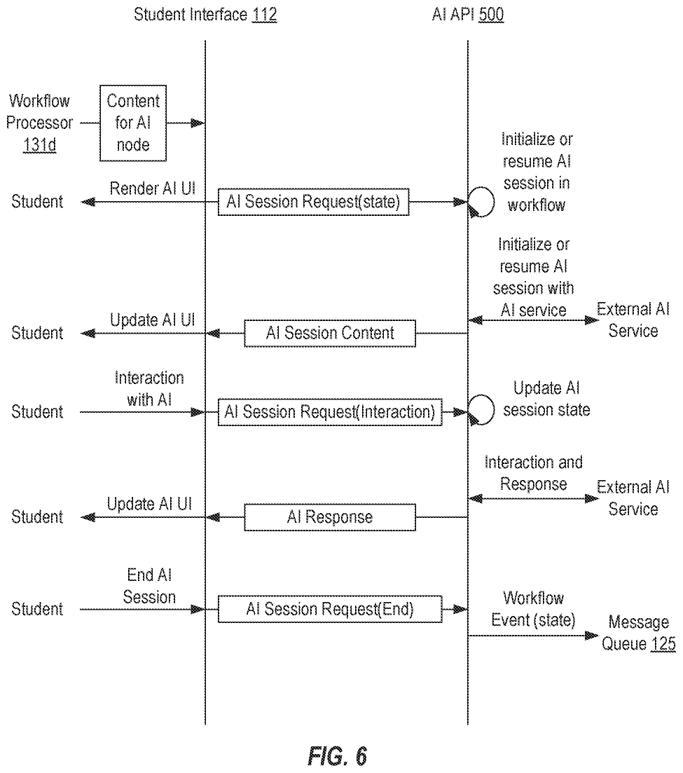

FIG. 6 is a flow diagram representing how student interface 112 and AI API 500 can interact when a workflow includes an AI node to provide AI functionality. The flow diagram commences with student interface 112 receiving content for the AI node as is represented in FIG. 5A. The logic of student interface 112 can be configured to detect when the currently executing node is an AI node (e.g., from the content for the AI node) and can then commence interfacing with AI API 500 to implement an AI session. For example, in FIG. 6, student interface 112 may initially render a default AI UI in conjunction with sending an AI session request to AI API 500. This AI session request can include a parameter that identifies a state of the AI session. If the AI session is being newly created, the state parameter may be null. Otherwise, if the AI session request is sent during an active AI session, the state parameter may define the state of the AI session.

In response to receiving the AI session request, AI API 500 can initialize a new AI session if the state is null or can resume/continue the AI session defined by the state. Additionally, AI API 500 may interface with an external AI service (e.g., ChatGPT or Google Bard) to initiate or resume/continue an AI session. For example, if the AI node defines a quiz that the student is starting, AI API 500 can initialize the AI session within the workflow by creating AI session content that student interface 112 can use to render an AI UI to present the quiz to the student (e.g., instructions and can incorporate AI-generated content (e.g., a questions and answers) received from the external AI service into the AI session content). In contrast, if the AI session is being resumed, AI API 500 could retrieve a log of AI-generated content and student interactions with such content and include it in the AI session content. In short, AI API 500 allows student interface 112 to dynamically render an AI UI in which an AI session may be presented to the student. Upon receiving the AI session content, student interface 112 may update the AI UI and present it to the student (e.g., as represented in FIGS. 5B and 7B).

The flow diagram of FIG. 6 then shows that the student may interact with the AI (i.e., the student may provide input to the AI UI to interact with the AI-generated content such as by chatting with the AI caveman or answering an AI-generated question). Student interface 112 can respond to this interaction by sending another AI session request to AI API 500 which includes the interaction (e.g., the text input by the student, an answer selected by the student, etc.). AI API 500 can then update the AI session state to reflect the interaction and may also interface with the external AI service to submit the interaction and receive a response (e.g., a response from the caveman, confirmation of the correct answer, etc.). AI API 500 can then send the AI response (which can be considered AI session content) back to student interface 112 to allow student interface 112 to update the AI UI appropriately. This process can be repeated whenever the student interacts with the AI.

Finally, when student interface 112 detects that the student has requested to end the AI session (or otherwise has determined that the AI session should end such as based on the logic of the AI node), student interface 112 can send AI API 500 an AI session request that requests the end of the AI session. In response, AI API 500 can generate a workflow event indicative of the end of the AI session which also defines the AI session state and deliver the event to message queue 125 for routing to workflow processor 131d. Workflow processor 131d can respond to this event in a similar manner as described above to determine whether execution of the workflow should proceed from the AI node to the next node. For example, based on the returned AI session state, workflow processor 131d could determine what grade the student earned on the quiz and may determine the next node accordingly as is represented in FIG. 7A.

Accordingly, embodiments of the present invention allow AI-functionality to be integrated using structured workflows that include AI nodes. The AI nodes allow the student's AI interactions to generate outputs for controlling the progression of the workflow.

In some embodiments, workflows may be shareable between schools or other organizations that may use the system. For example, after an admin has used visual workflow editor 200 to create a workflow template defining a workflow, he or she could choose to share the workflow by simply allowing the workflow template to be used by admins and/or teachers at other schools. The structure of the workflow templates makes this sharing simple without exposing sensitive information about the students or teachers that may use the workflows.

In summary, embodiments of the present invention allow admins to create, using a flow-based visual model, workflows consisting of sequences of activities, information and events which teachers can assign to students or for which students may volunteer. The activities of these workflows can be time-limited, can transact across home life, school life and external systems and can require parents and/or teachers to trigger events to continue the execution of the workflows. The above-described architecture enables this complex functionality to be provided in a scalable and user-friendly manner.

In some embodiments, workflows can be configured to link real-world achievements with discoverable metaverse achievements. In such embodiments, the workflows could also be used to control student access to the metaverse in which the achievements are discoverable. In some embodiments, a metaverse node can be defined and made available to admins for inclusion in any workflow. Other types of nodes, such as incentive nodes, can be configured to allow the admin to specify whether a corresponding achievement or other interaction should occur in the metaverse rather than in the real world.

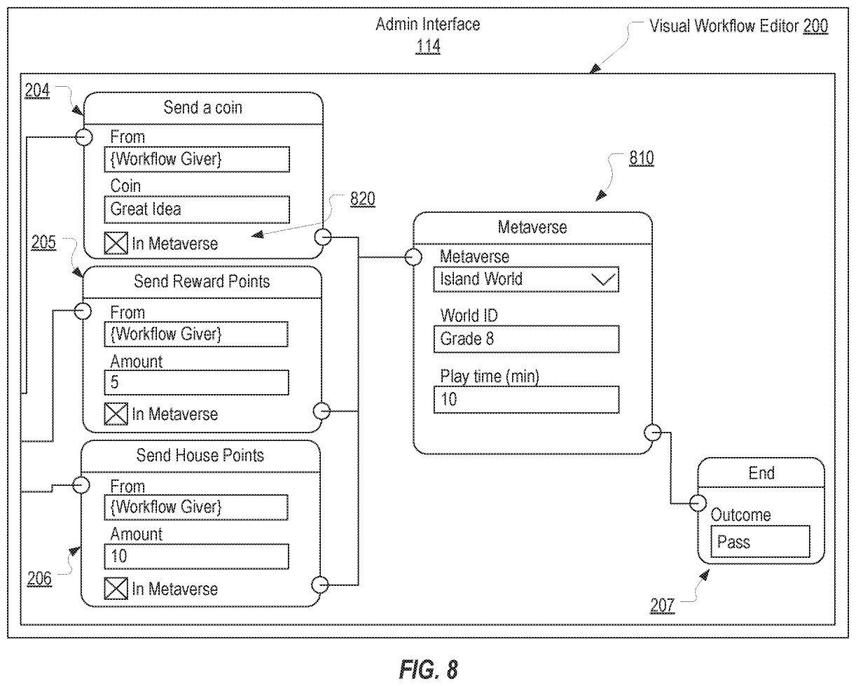

FIG. 8, which is based on FIG. 2G, provides an example of how visual workflow editor 200 allows an admin to create a workflow that links real-world achievements with discoverable metaverse achievements. As shown, the admin has added a metaverse node 810 to the workflow between nodes 204, 205, and 206 and end node 207. In other words, metaverse node 810 is configured to be invoked after nodes 204, 205, and 206 have been invoked to issue achievements to the student. Also, each of nodes 204, 205, and 206 include an “In Metaverse” option 820 that can be selected to cause the corresponding achievement to be issued in the metaverse defined by metaverse node 810 (as opposed to issuing the achievement immediately). Option 820 is selected in each of nodes 204, 205, and 206 indicating that their corresponding achievements will be issued in the metaverse.

Metaverse node 810 includes an option for selecting the type of metaverse (e.g., Island World, Cloud World, etc.), an option, which could be optional, for selecting an identifier of a particular metaverse instance (e.g., an instance of the Island World that is specific to 8th graders), and an option to define the amount of play time the student will have in the metaverse (e.g., 10 minutes). In short, to integrate a metaverse into a workflow, an admin need only configure a metaverse node to define which metaverse instance should be launched when the workflow is executed and to define how long a student should be allowed to play in the metaverse. The admin may also define which achievements awarded via the workflow, if any, should be distributed in the metaverse.

FIG. 8 is only one example of how a metaverse node 810 could be used in a workflow. In some embodiments, an admin could integrate a metaverse node 810 in any workflow such as a workflow for presenting a quiz or test to students where the metaverse node 810 is integrated to allow the students to play in the metaverse after completing the quiz or test.

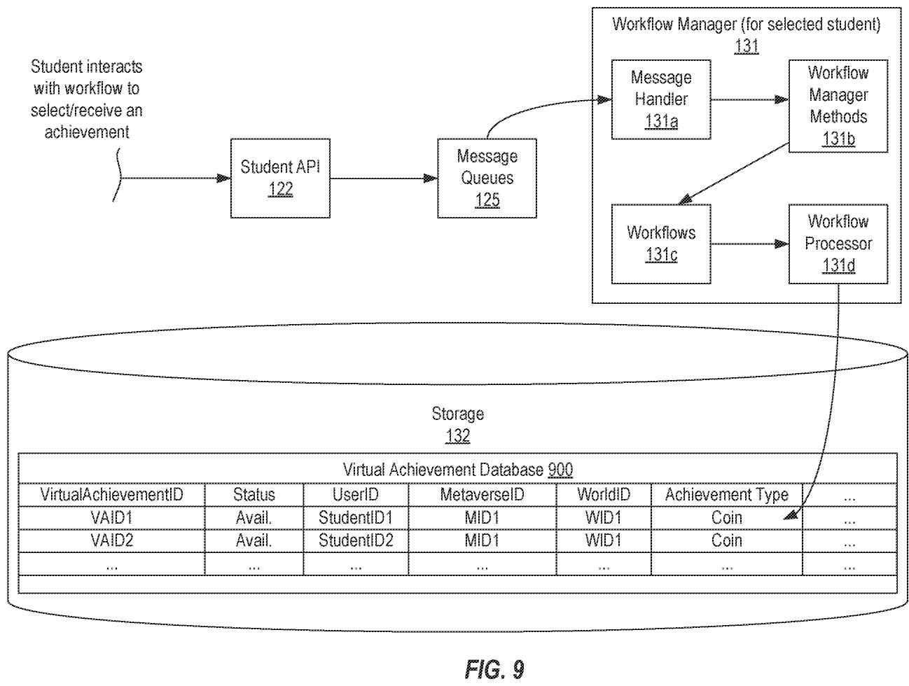

When a node includes option 820 for issuing an achievement in the metaverse, the processing of the node during the workflow's execution may be different from what is described above. For example, FIGS. 4A-4D, and particularly FIG. 4D, provided an example where workflow processor 131d executed node 204 to immediately award the “Great idea” coin to the student. However, in embodiments where node 204 is configured with option 820 set, workflow processor 131d's execution of node 204 will result in a record being created in a virtual achievement database. FIG. 9 provides an example of how this may be accomplished.

FIG. 9 is based on FIG. 4D but assumes that the student has interacted with a workflow that includes an achievement node having option 820 set. The student's interaction with the workflow can be handled in a similar manner as described above with reference to FIGS. 4A-4D. However, when the achievement node is executed, workflow processor 131d can detect that option 820 is set. In response, workflow processor 131d can interface with a virtual achievement database 900, which may be maintained in storage 132, to create a record representing the achievement defined in the achievement node. Virtual achievement database 900 provides a mechanism for tracking and identifying achievements that have been made available to students for discovery in a metaverse.

As shown, a record in virtual achievement database 900 may include an identifier for the virtual achievement, a status (e.g., whether the virtual achievement is available, issued, or errored), a user ID of the student with whom the achievement is associated, an identifier of the metaverse and the world in which the achievement has been or will be made available, a type of the achievement, etc. Notably, in FIG. 9, each depicted record has been fully populated. However, in some embodiments, a record in virtual achievement database 900 may not initially include a metaverse ID or a world ID until the metaverse node 810 in the workflow has been executed as is further described below. In other words, upon executing an achievement node with option 820 set, workflow processor 131d may initially create a record containing a virtual achievement ID, a status, a user ID and an achievement type. Then, upon executing the metaverse node 810, workflow processor 131d may update the record with the metaverse ID and the world ID (if specified). Accordingly, virtual achievement database 900 defines which achievements have been made available to particular students for discovery in the metaverse.

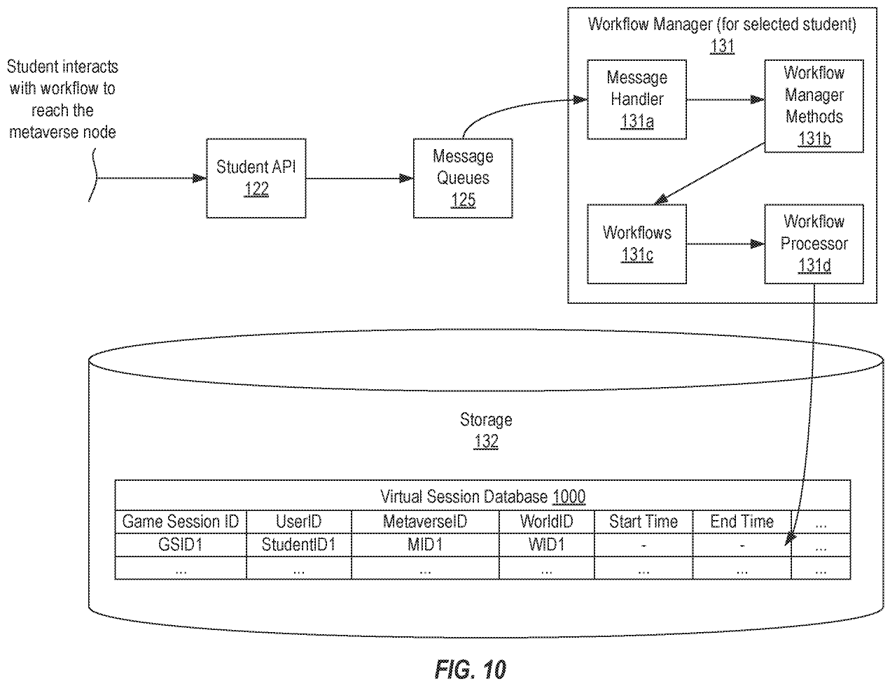

FIG. 10 provides an example of a virtual session database 1000 that workflow processor 131d may employ to manage metaverse instances that are deployed when metaverse node 810 is executed. A record in virtual session database 1000 can include an identifier of a game session (i.e., an identifier of the particular instance of the metaverse that is launched for a student), a user identifier of the student for whom the metaverse is launched, identifiers of the metaverse and world (if specified) and start and end times for the game session. Upon executing metaverse node 810 in a workflow, workflow processor 131d can create and populate a record in virtual session database 1000. As represented in FIG. 10, workflow processor 131d may not initially populate the start and end times for the reasons given below.

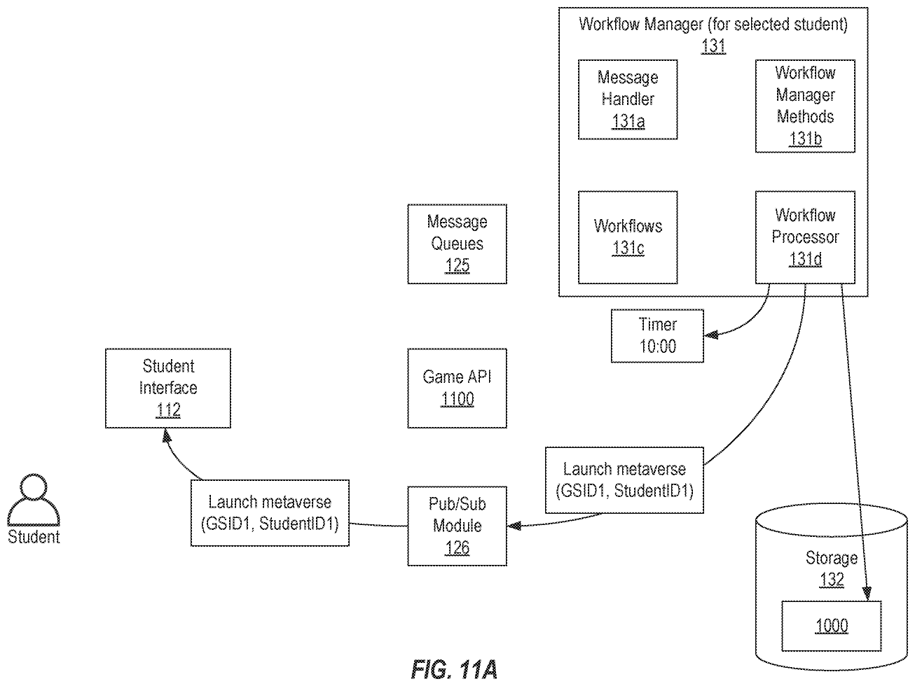

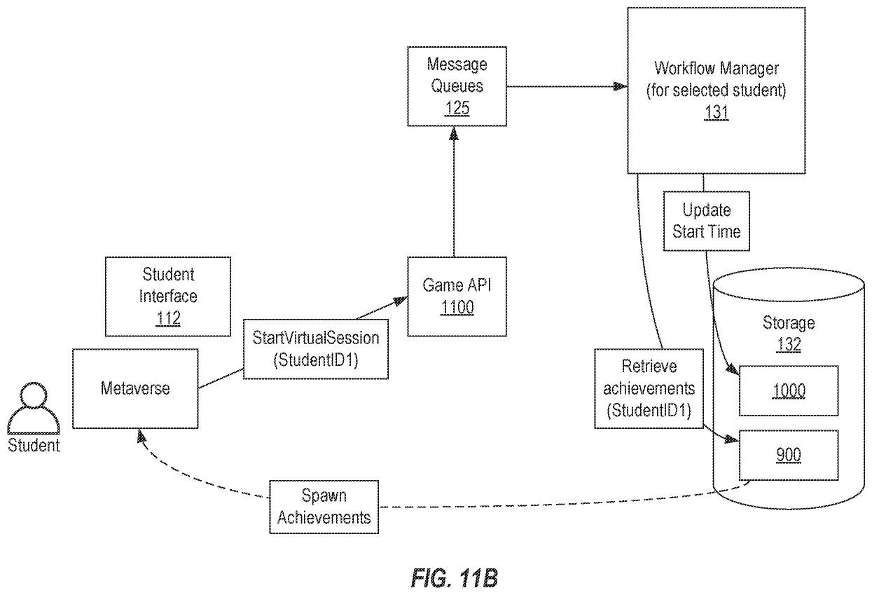

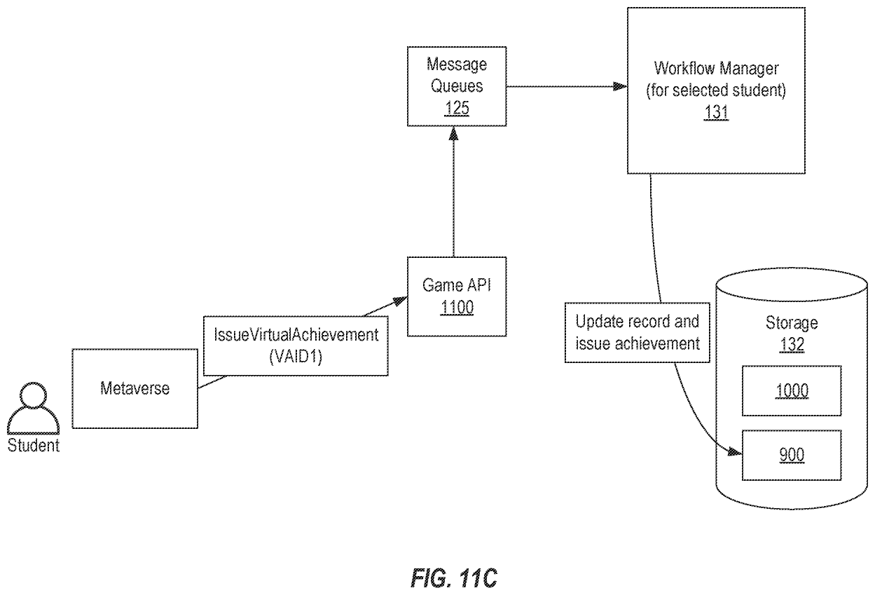

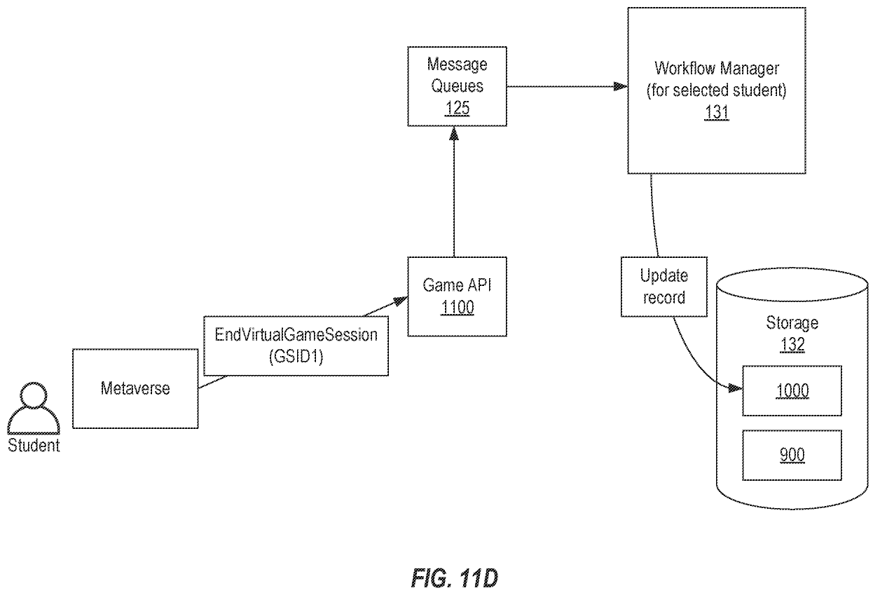

FIGS. 11A-11D provide an example of how a metaverse instance can be launched in response to executing metaverse node 910 in a workflow to thereby allow a student to discover achievements within the metaverse.

FIG. 11A represents functionality that workflow processor 131d can perform in response to executing metaverse node 810. In addition to creating a record in virtual session database 1000 as described above, workflow processor 131d may also instantiate a timer based on the play time parameter specified in metaverse node 810 and may interface with student interface 112 (e.g., via pub/sub module 126) to cause the metaverse instance to be launched on the student's device. For example, workflow processor 131d could cause a browser window to be launched to run the metaverse instance and could log the student in to the metaverse instance. As part of causing the metaverse instance to be launched, workflow processor 131d can provide the identifier of the game session (e.g., GSID1).

Turning to FIG. 11B, in conjunction with the launching of the metaverse instance, the metaverse instance can be configured to interface with a game API 1100 to start the game session. For example, the metaverse instance can call a StartVirtualSession API and provide the user ID of the student (e.g., StudentID1). This call can be processed through workflow manager 131 in a similar manner as described above. Additionally, workflow manager 131 can respond by updating the corresponding record in virtual session database 1000 to include the start time and can access virtual achievement database 900 to retrieve each virtual achievement that is associated with the student and has not yet been issued (e.g., by identifying each record having StudentID1 as the user ID and a status of available). Each matching achievement can be returned to the metaverse instance (e.g., via pub/sub module 126) for spawning in the metaverse (e.g., at random locations). In some embodiments, a 3D model and/or other information for rendering the virtual achievement can be returned as part of this step.

Turning to FIG. 11C, it is now assumed that the student is playing in the metaverse and has discovered one of the virtual achievements that has been spawned therein (e.g., by visiting the location where the achievement was spawned). In response to the student discovering the virtual achievement, the metaverse instance can interface with game API 1100 to request issuance of the virtual achievement such as by calling an Issue VirtualAchievement API and specifying the identifier of the virtual achievement. Workflow manager 131 can respond by accessing virtual achievement database 900 to update the corresponding record (e.g., to set the status of the corresponding record to issued) and to obtain any other information necessary to issue the corresponding achievement in the real world (e.g., by awarding the coin in the student's account).

Turning to FIG. 11D, when the timer elapses or the student otherwise ends the metaverse instance, the metaverse instance may interface with game API 1100 to end the virtual session such as by calling the EndVirtualGameSession API and specifying the identifier of the game session. In response, workflow manager 131 can update the corresponding record in virtual session database 1000 to include the end time of the game session. In this way, virtual session database 1000 can reflect the amount of time each student has spent playing in the metaverse.

Embodiments of the present invention may comprise or utilize special purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media are categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves. Because computer storage media and transmission media are disjoint categories, computer storage media does not include signals or carrier waves.

Computer-executable instructions comprise, for example, instructions and data which, when executed by a processor, cause a general-purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, smart watches, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method for implementing workflows for supporting interactions across multiple learning environments and systems, the method comprising:
receiving, via a visual workflow editor, input that defines a plurality of nodes and interconnects the nodes to form a first workflow, the plurality of nodes including a metaverse node;
starting the first workflow for a student;
upon reaching the metaverse node of the first workflow, launching a metaverse instance; and
placing one or more virtual achievements in the metaverse instance, the one or more virtual achievements being defined in the first workflow.

2. The method of claim 1, wherein the plurality of nodes include one or more achievement nodes that define the one or more virtual achievements.

3. The method of claim 2, wherein the one or more achievement nodes define one or more achievements and specify an option to cause the one or more achievements to be made available as the one or more virtual achievements in the metaverse instance.

4. The method of claim 1, wherein the metaverse node identifies a type of the metaverse instance.

5. The method of claim 4, wherein the metaverse node specifies an identifier of a world for the metaverse instance.

6. The method of claim 1, wherein the metaverse node specifies a play time, the method further comprising:
determining that the play time has elapsed; and
terminating the metaverse instance.

7. The method of claim 1, further comprising:
generating a first workflow template for the first workflow, the first workflow template comprising a textual representation of each of the nodes including any inputs, parameters and outputs for the nodes;
wherein starting the first workflow for the student comprises converting the first workflow template into an object model for the first workflow and executing the object model for the first workflow in a workflow processor.

8. The method of claim 1, wherein at least one of the plurality of nodes is configured to provide artificial intelligence (AI) functionality, and wherein the method further comprises:
interfacing, by a student interface that presents a user interface representing the first workflow to the student, with an AI application programming interface (API) to integrate the AI functionality into the user interface.

9. The method of claim 1, wherein launching the metaverse instance comprises logging the student in to the metaverse instance.

10. The method of claim 1, wherein the one or more virtual achievements are identified by querying a virtual achievement database using an identifier of the student.

11. The method of claim 10, wherein the one or more virtual achievements are defined in the virtual achievement database in response to executing one or more corresponding achievement nodes in the first workflow.

12. The method of claim 1, further comprising:
in response to the student discovering a first virtual achievement of the one or more virtual achievements in the metaverse instance, issuing a first achievement corresponding to the first virtual achievement to the student.

13. The method of claim 1, wherein the plurality of nodes includes one or more achievement nodes corresponding to the one or more virtual achievements, the method further comprising:
upon reaching each of the one or more achievement nodes, creating a record in a virtual achievement database defining the corresponding virtual achievement;
wherein placing the one or more virtual achievements in the metaverse instance comprises accessing the virtual achievement database to identify the one or more records defining the one or more virtual achievements.

14. A method for implementing workflows for supporting interactions across multiple learning environments and systems, the method comprising:
receiving, via a visual workflow editor, input that defines a plurality of nodes and interconnects the nodes to form a first workflow, the plurality of nodes including a first achievement node and a metaverse node;
starting the first workflow for a student;
upon reaching the first achievement node, determining that the first achievement node defines an achievement that should be made available to the student as a first virtual achievement;
upon reaching the metaverse node of the first workflow, launching a metaverse instance; and
placing the first virtual achievement in the metaverse instance.

15. The method of claim 14, further comprising:
creating a record in a virtual achievement database for the first virtual achievement;
wherein placing the first virtual achievement in the metaverse instance comprises accessing the virtual achievement database to locate the record.

16. The method of claim 15, further comprising:
determining that the student has located the first virtual achievement in the metaverse instance; and
updating the record in the virtual achievement database.

17. The method of claim 14, further comprising:
terminating the metaverse instance after a timer specified in the metaverse node has elapsed.

18. One or more computer storage media storing computer executable instructions which when executed perform a method for implementing workflows for supporting interactions across multiple learning environments and systems, the method comprising:
starting a first workflow for a student;
as part of executing an achievement node of the first workflow, determining that the achievement node specifies that an achievement defined in the achievement node is to be made available to the student as a virtual achievement in a metaverse;
creating a record representing the virtual achievement;
in response to executing a metaverse node of the first workflow, launching a metaverse instance for the student;
accessing the record to identify the virtual achievement; and
spawning the virtual achievement in the metaverse instance.

19. The computer storage media of claim 18, wherein the method further comprises:
determining that the student has located the virtual achievement in the metaverse instance; and
issuing the achievement to the student.

20. The computer storage media of claim 18, wherein the method further comprises:
terminating the metaverse instance upon detecting that a play time specified in the metaverse node has elapsed.
